(19) United States
(12) Patent Application Publication
(10) Pub. No.: US 2026/0166478 A1
(43) Pub. Date: Jun. 18, 2026

(54) SELECTIVE MEMBRANES AND RELATED METHODS

(71) Applicant: Massachusetts Institute of Technology, Cambridge, MA (US)

(72) Inventors: Rohit N. Karnik, Cambridge, MA (US); Randall Perkins Field, Andover, MA (US); Aaron Persad, Somerville, MA (US); Chi David Cheng, Providence, RI (US); Lohyun Kim, Cambridge, MA (US)

(73) Assignee: Massachusetts Institute of Technology, Cambridge, MA (US)

(21) Appl. No.: 19/125,243

(22) PCT Filed: Nov. 21, 2023
(86) PCT No.: PCT/US2023/080744

§ 371 Date: Apr. 28, 2025

Related U.S. Application Data
(60) Provisional application No. 63/427,712, filed on Nov. 23, 2022.

(51) Int. Cl. B01D 53/22; B01D 67/00; C01B 3/503

(52) U.S. Cl. CPC B01D 53/228; B01D 67/0062; C01B 3/503

(57) ABSTRACT

Hydrogen selective membranes and related methods are generally described. In some embodiments, a hydrogen selective membrane may exhibit high permeance and selectivity in comparison to conventional polymer membranes, at low material costs. The membrane may also be thermally and chemically stable at high operational temperatures. In some embodiments, the membrane may include a layer of inorganic material (e.g., palladium) and a layer of atomically thin material (e.g., graphene) arranged on a porous substrate. The inorganic material may be arranged in a film-like or an isolated island-type architecture. In other embodiments, the inorganic material may be arranged within the pores of the porous substrate in an isolated plug-type fashion.

### RELATED APPLICATIONS

This application claims the benefit of priority under 35 U.S.C. § 119(e) to U.S. Provisional Application Ser. No. 63/427,712, filed Nov. 23, 2022, the disclosure of which is incorporated herein by reference in its entirety.

### FIELD

Disclosed embodiments are related to hydrogen selective membrane systems and related methods. More specifically, membranes and methods for enhanced hydrogen selectivity and permeance in a low-cost and thermally stable manner are described.

### BACKGROUND

Hydrogen is one of the most important materials used in various industries. Its demand has increased exponentially over time, which in turn has increased its production rate. Traditionally, most industrial hydrogen was consumed for ammonia production, petroleum refining, and methanol production, but the range of hydrogen consumption applications has continued to expand to include hydrogen as an energy carrier to power ground transportation, ships, and the space industry.

These growing needs require hydrogen production on the order of billions of cubic meters per day. One of the major methods to produce hydrogen is steam methane reforming, which accounts for ˜50% of total hydrogen production, owing to its low cost. The products of the methane reaction, however, include some impurities, such as carbon dioxide, or carbon monoxide, which limits the purity of the gas and subsequently decreases the production yield and efficiency in industries requiring pure hydrogen. Other means of hydrogen production using clean energy are also likely to grow in the future, along with expansion of the use of hydrogen for new applications such as ship propulsion. The production and purification of hydrogen, hence, becomes more critical to resolve these issues.

### SUMMARY

In some embodiments, a membrane includes a porous support layer, an atomically thin layer disposed on the porous support layer, wherein the atomically thin layer includes a plurality of pores, and a layer disposed on the atomically thin layer, wherein the layer is formed of a hydrogen selective material.

In other embodiments, a membrane includes a porous support layer including a plurality of pores and a plurality of isolated plugs disposed at least partially in the plurality of the porous support layer, wherein the plurality of isolated plugs are isolated from one another, and wherein the plurality of isolated plugs are formed of a hydrogen selective material.

In some aspects, a membrane is provided. According to some embodiments, the membrane comprises: a porous support layer; an atomically thin layer disposed on the porous support layer, wherein the atomically thin layer includes a plurality of pores that includes non-gas-selective defects in the atomically thin layer; and a layer disposed on the atomically thin layer and arranged as a plurality of isolated microstructures, wherein the layer is formed of a material, and wherein at least some of the non-gas-selective defects of the plurality of pores are covered by the isolated microstructures.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 depicts a hydrogen-selective membrane according to some embodiments;

FIG. 2 depicts a process of fabricating the membrane of FIG. 1, according to some embodiments;

FIG. 3A shows an exemplary plot of permeance of various gases through a hydrogen membrane vs. processing conditions;

FIG. 3B shows an exemplary plot of selectivity of various gases through a hydrogen membrane vs. processing conditions;

FIG. 3C shows a table summarizing the data from FIGS. 3B-3C;

FIG. 4 depicts a hydrogen membrane according to other embodiments;

FIGS. 5A-5C shows various SEMs of the hydrogen membrane of FIG. 4, according to some embodiments;

FIG. 6 depicts a hydrogen membrane according to other embodiments still;

FIGS. 7A-7D depict a process of fabricating the membrane of FIG. 6, according to some embodiments;

FIGS. 8A-8B show exemplary SEMs of the hydrogen membrane of FIG. 6;

FIG. 9A depicts another process of fabricating the membrane of FIG. 6, according to some embodiments;

FIG. 9B depicts an electrodeposition system suitable for the process of FIG. 9A, according to some embodiments

FIGS. 10A-10B show exemplary plots of gas permeance vs. processing conditions;

FIGS. 11A-11B depict a gas transport model according to some embodiments;

FIG. 11C shows an exemplary plot of permeance and material porosity vs. oxygen plasma exposure;

FIGS. 12A-12B show exemplary plots of permeance and selectivity vs. oxygen plasma exposure;

FIGS. 13A-13B show exemplary plots of permeance of various gases vs. pressure and temperature;

FIG. 14A depicts a schematic of anisotropic expansion of an inorganic material lattice, according to some embodiments;

FIGS. 14B-14C show exemplary plots of permeance of various gases

FIG. 15A shows an SEM micrograph of an island-type membrane, according to some embodiments;

FIG. 15B shows helium selectivity of various gasses through island-type membranes, according to some embodiments;

FIG. 15C shows normalized flow rate (normalized by support flow rate) of various gasses through island-type membranes, according to some embodiments;

FIG. 15D shows the position of an island-type membrane on a Robeson plot, according to some embodiments;

FIG. 16A shows an SEM micrograph of a cross-section of a plug-type membrane, according to some embodiments; and

FIG. 16B shows the single-gas permeance and hydrogen selectivity of a plug-type membrane and a commercially available Pd foil membrane, according to some embodiments.

### DETAILED DESCRIPTION

Conventional hydrogen separation is performed using pressure-swing adsorption with zeolites and membrane separations. In particular, membrane technologies have attracted wide interest among processes for separating hydrogen from other impurities due to advantages in ease of operation, modularity, low energy consumption, and cost-effectiveness. Among several types of membranes, polymeric membranes have already been implemented in industries for hydrogen separation owing to their low cost and stability under the conditions of high pressure drops. However, the Inventors have appreciated that polymeric membranes generally show a trade-off between hydrogen selectivity and permeability. For example, polymeric membranes having high permeability (e.g. rubbery polymer) show low selectivity and vice versa for others, such as glassy polymers. The Inventors have therefore recognized that polymeric membranes cannot expect higher permeability to hydrogen without compensating for gas selectivity. Moreover, the operating temperature of the membrane is limited to the glass transition temperature of the constitutive polymer, which is typically lower than 400 K, which may be unsuitable for a variety of applications.

To overcome the shortcomings of polymeric membranes, different types of new membranes are being developed. Examples include membranes based on polymers with intrinsic porosity, mixed-matrix membranes based on porous nanomaterials such as metal-oxide frameworks, covalent organic frameworks, zeolites, and atomically thin materials, among others. Membranes with atomically thin materials (e.g., two-dimensional) materials, such as graphene or hexagonal boron nitride (hBN), have the added benefit of stability at higher temperatures (>1000 K) under an inert or non-oxidizing environment. In some cases, atomically thin materials can enhance the hydrogen permeance, the permeability of the membrane with unit thickness, owing to their atomic thickness, as well as the selectivity using molecular sieving mechanism. Membranes having atomically thin layers are typically characterized using permeance rather than permeability, since the thickness is fixed to the size of the atoms. Without wishing to be bound by theory, atomically thin layers further selectively permeate the gas species smaller than the size of the pores of the membrane enabling high selectivity. However, the Inventors have recognized that the steric effect can be effective only if the pores are created with the proper size and distribution (pores larger than a hydrogen molecule but smaller than other gases), which may not be easy to realize using current state-of-the-art technology, which limits the potential selectivity of an atomically thin membrane. The Inventors have also recognized that some atomically thin materials, such as graphene and hBN, can also pass protons through their lattice, thus exhibiting selectivity between hydrogen isotopes.

Alternatively, inorganic membranes, especially metal-based membranes (e.g., palladium), have been studied as an alternative for hydrogen selective membranes due to the selective absorption and diffusion of hydrogen by solution-diffusion mechanisms of metals. This phenomenon enables hydrogen selectivity of 10²˜10⁴ against nitrogen, depending on the film properties (e.g., grain boundaries, defect density). Moreover, metallic membranes can typically operate at elevated temperatures in the range of 600 to 1000 K. The permeability drops to very low values at room temperature, and the membranes may suffer from hydrogen embrittlement below about 600 K. The Inventors have recognized that metal layers are inherently unstable at high temperatures, and hence these membranes cannot operate for extended periods at temperatures exceeding 1000 K. At high temperatures (>1000 K), the performance of palladium-based membranes can be deteriorated due to (1) the intermetallic diffusion between palladium and other metals adjacent to the membranes, and (2) thermal deformation of the palladium film due to the high surface energy.

In addition, a major setback of metallic membranes is related to the cost of the material. For example, palladium, one of the most promising materials for hydrogen selective membrane, costs almost 85,000 USD/kg, which is even more expensive than gold (64,000 USD/kg). Furthermore, conventional membranes having thick metal foils of several microns decreases the hydrogen permeance since the permeance is inversely proportional to the thickness of the membrane under the assumption of diffusion-limited transport. These necessitate the development of the metallic composite membrane having a thin metal layer deposited on porous support (e.g., alumina, sintered stainless steel). The metal composite membrane, however, shows lower hydrogen selectivity as the thickness decreases since the thin metal layer includes several defects which allow other gas species to pass through. Furthermore, the Inventors have recognized that thin metallic films on ceramic supports are generally even more unstable at high temperatures due to its high surface energy. Long-term exposure to high temperature conditions can cause the evolution of large pinholes on the metal film, which eventually deforms the entire film into discrete islands (solid-state dewetting).

In view of the above, the Inventors have recognized the benefits associated with membranes for hydrogen purification. The Inventors have also recognized that preferential sealing of large pores in atomically thin layers of membranes may be used as a hydrogen selection mechanism. In some cases, large pores may be sealed using inorganic materials, e.g., in the form of island-type inorganic materials covering large pores of the atomically thin layers. In some cases, the membranes may be low-cost, stable at high operational temperatures for prolonged periods, and exhibit high hydrogen selectivity and permeability for efficient purification. The membranes may employ thin inorganic layers, which both reduce costs and enhance hydrogen permeance while retaining selectivity. However, instances in which different benefits are offered by the systems and methods disclosed herein are also possible.

In some embodiments, hydrogen selective membranes may include a thin hydrogen selective layer formed of an inorganic (e.g., metal) material, to reduce costs and increase hydrogen permeance and selectivity by enabling additional transport pathways that favor hydrogen. In some embodiments, the inorganic layer may be supported by an atomically thin material (e.g., graphene or hBN), and may further enhance the selectivity, including hydrogen isotope selectivity in some cases, of the membrane. The atomically thin material may serve as a barrier between a porous support on which the inorganic layer is disposed and the inorganic layer itself, reducing the risk of diffusion between the two materials.

Hydrogen selectivity of the membrane may also be achieved by at least some membranes provided herein without reliance on a hydrogen selective layer. In at least some embodiments, hydrogen selectivity of the membrane is achieved by a molecular sieving effect (e.g., Knudsen transport). For example, in some embodiments, a hydrogen selective membrane comprises a porous atomically thin material, and an inorganic layer provided herein is provided to selectively seal pores in a porous, atomically thin material, as described in greater detail below. For example, islands of the inorganic layer may selectively form above pores (in particular, larger pores) of the atomically thin material, blocking the passage of larger molecules through the larger pores of the atomically thin material and improving the suitability of the atomically thin material for molecular sieving (e.g., through smaller pores in the atomically thin material that have not been covered by the inorganic layer, or through smaller or larger pores that are partially blocked by the inorganic layer such that they allow preferential passage of smaller molecules). Molecular sieving may provide certain advantages for hydrogen selective membrane transport. For example, without wishing to be bound by any particular theory, molecular sieving (e.g., Knudsen transport) may allow the membranes to operate at relatively low temperatures relative to solution-diffusion mechanisms, allowing hydrogen selectivity at relatively low temperatures, e.g., room temperature.

According to some embodiments, molecular sieving is accomplished without using a non-hydrogen-selective material. For example, in some embodiments, a membrane provided herein comprises islands or nanostructures as described herein that are made of a non-hydrogen-selective material. Molecular sieving, regardless of whether a hydrogen-selective material or a non-hydrogen-selective material is used, may be used to selectively filter hydrogen or a gas species other than hydrogen, depending on the embodiment. For example, molecular sieving may be used to separate helium, depending on the embodiment. Molecular sieving of other gas species is also possible using a membrane provided herein, as the disclosure is not so limited. A few, non-limiting examples of gases that may be separated using a membrane provided herein include hydrogen from methane; helium from hydrogen; ethane from ethylene; air from volatile organic compounds; hydrogen from natural gas; hydrogen from tetralin, decalin, and naphthalene; hydrogen from hydrocarbons; propane and larger hydrocarbons from natural gas; methane from carbon dioxide, hydrogen from oxygen or nitrogen; and helium from air. Other, non-limiting separations that may be performed using a membrane provided herein include filtration of liquids, such as: salts from water; solutes from organic liquids such as isopropanol, acetonitrile, toluene, xylene, tetrachloroethene; separation of liquid-liquid mixtures such as water and isopropanol, water and ethanol, ethanol and toluene, methyl ethyl ketone and water; separation of hydrocarbons such as hexane from its isomers, hexane from cyclohexane, benzene from toluene, isomers of xylene; separation of solutes such as smaller ions from larger ions, smaller drug molecules from larger drug molecules.

In another aspect, methods of filtering a gas are provided. In some embodiments, a gas is filtered by flowing a species included in the gas through a membrane as provided herein. The species may be hydrogen, or may be a non-hydrogen species, depending on the embodiment. Embodiments of membranes and methods with both hydrogen selective layers and non-hydrogen-selective layers are described in greater detail below.

In some embodiments, the hydrogen selective membranes may include a thin inorganic film conformally disposed on top of an atomically thin layer, both of which may be arranged on a porous support. In some embodiments, the hydrogen selective membranes include discrete and isolated nanostructures, which may have at least one transverse dimension in the nanoscale (i.e., less than or equal to 1,000 nm). For example, the hydrogen selective membranes may comprise nanoparticles (e.g., particles having a maximum transverse dimension of less than or equal to 1,000 nm). In other embodiments, the hydrogen selective membranes may include discrete and isolated inorganic islands arranged on top of an atomically thin layer, both of which may be arranged on a porous support. The islands may be at least partially aligned with the pores of the porous support for enhanced selectivity. In other embodiments still, the hydrogen selective membranes may include discrete and isolated inorganic plugs arranged at least partially within the pores of a porous support. These embodiments may or may not include an atomically thin layer. The inorganic materials in these embodiments may or may not be hydrogen selective, depending on the embodiment.

According to some embodiments, a thin, inorganic film comprising discrete and isolated structures is configured such that the discrete and isolated structures (e.g., islands or other nanostructures) change a distribution of uncovered pore sizes of a porous, atomically thin layer disposed beneath the inorganic film. For example, in some embodiments a porous, atomically thin material comprises a plurality of pores with a polydisperse size distribution (e.g., the plurality of pores may have a characteristic dimension, such as a diameter, that is broadly distributed). For example, the atomically thin material may comprise a plurality of pores that includes both small pores capable of gas selection and large, defect pores incapable of gas selection. Fluid flow through the atomically thin layer may relate to the size and dimensions of the uncovered pores of the plurality, e.g., such that fluid flow through the atomically thin layer predominantly occurs via large, defect pores of the plurality of pores of a porous, atomically thin layer in isolation. The addition of a thin, inorganic film to the top of the atomically thin layer may be performed such that discrete and isolated structures preferentially associate with pores and, in particular, associate with large, defect pores of the plurality. In some embodiments, for example, covering the top of the atomically thin layer with the inorganic layer leaves a plurality of small pores of the atomically thin layer uncovered while covering larger defects with the discrete and isolated structures (e.g., the islands or the other nanostructures). In some embodiments, the plurality of uncovered pores of a membrane is relatively small. The plurality of uncovered pores may have a relatively monodispersed size distribution (e.g., the plurality of uncovered pores may have a characteristic dimension, such as a diameter, that is narrowly distributed relative to the distribution of the characteristic dimension of the uncovered pores). According to some embodiments, the uncovered pores provide the dominant path for fluid transport through the membrane after the inorganic film is added. Such a membrane may act as a molecular sieve, since smaller, relatively monodispersed pores may be associated with differences in effusive transport of gas molecules based at least in part on the size of the gas molecules.

In some embodiments, the inorganic layer may include isolated inorganic structures. For example, the island-type membranes may include separated inorganic particles distributed on a porous surface such as a porous layer of an atomically thin layer disposed on a porous support. In some embodiments, an inorganic layer or structures may be disposed on both sides of an atomically thin layer on a porous support. In some embodiments, the inorganic material may be arranged between the porous support and the atomically thin layer, and on the side of the atomically thin layer that is not facing the porous support. In any of the embodiments described herein, the inorganic material may facilitate dissociation of hydrogen (or hydrogen isotope) molecules, transport of protons across the atomically thin layer, and their recombination into hydrogen molecules. In some embodiments, an inorganic layer or inorganic structures may be disposed on both sides of two or more stacked atomically thin layers on a porous support, where the atomically thin layers may or may not contain pores. In some embodiments, the atomically thin layer or layers allow the passage of hydrogen atoms or protons. In some embodiments, stacking of atomically thin layers may reduce leakage pathways through covering of defects in one layer by another layer. In other embodiments, the inorganic islands or structures may be interspersed in between two or more layers of atomically thin layers. In another example, the plug-type membranes may have inorganic particles sealing the discrete pores in a porous support. These structural characteristics may enable the membranes to be stable at high operational temperatures since the particles are already in a thermodynamically stable state by minimizing their surface area.

It should be appreciated that the membranes described herein may be employed for separation of any suitable material, including hydrogen isotopes, liquid, or a mixture of different phases.

In the film-type membranes, which include a porous inorganic layer, porous atomically thin layer, and porous support. The porous structure of the inorganic film allows hydrogen to permeate the layer through several transport pathways: 1) molecular diffusion through any pore voids, 2) surface diffusion along the inorganic surface, or 3) transport through the inorganic film (especially at high temperature via the solution-diffusion mechanism). These several pathways for hydrogen may increase the overall permeance while achieving high selectivity against other gas species since the only way those other gas species can infiltrate the layer is by molecular diffusion via the voids of the film.

In some embodiments, the atomically thin layer may be a two-dimensional material (e.g., graphene), and the inorganic film may be a metal (e.g., palladium). The atomically thin layer below the metal film may include pores through which the hydrogen can pass. The film may be deposited on a porous substrate formed of any suitable material, as will be described in greater detail below.

In some embodiments, the island-type membrane may present the same characteristics as the film-type membrane, except for the architecture of the inorganic layer. The membrane may include discrete inorganic (e.g., metallic) islands or particle structures distributed on a surface of the atomically thin layer. As will be described in greater detail below, the density of the islands can be adjusted by controlling the deposition and annealing cycles of the fabrication process. The metal islands may cover the pores on the surface of the porous support such that the volume of gas flow through pores of the porous support not covered by metal islands is less than the volume of gas flow through the metal islands, and the majority of the pores on the support may be covered by metal islands or otherwise blocked.

In some embodiments, an island-type membrane is disposed on a porous, atomically thin layer. In some embodiments, an island-type membrane comprises discrete inorganic (e.g., metallic) islands, nanoparticles, or other nanoscale structures distributed on the surface of the porous, atomically thin layer. The discrete inorganic islands, nanoparticles, or other nanoscale structures may cover larger pores on the surface of the porous atomically thin layer, such that the volume of gas flow through large, covered pores of the porous, atomically thin layer is less than the volume of gas flow through smaller, uncovered pores of the porous, atomically thin layer, allowing the smaller pores to act as a molecular sieve. For example, in some embodiments, the islands, nanoparticles, or other nanoscale structures are distributed such that the primary mechanism of gas flow through the pores is Knudsen transport. The inorganic material used in such island-type membranes need not be hydrogen selective in every embodiment. For example, in some embodiments, the island-type membrane may be hydrogen selective as a result of size-selection effects associated with transport of gas through the pores, and in such embodiments, the islands may simply act as a barrier to gas transport through larger, non-size-selective pores.

The islands, nanoparticles, or other nanoscale structures of an island-type membrane may have any of a variety of appropriate average arial diameters. In some embodiments, the islands, nanoparticles, or other nanoscale structures have an average arial diameter of greater than or equal to 0.5 nm, greater than or equal to 1 nm, greater than or equal to 2 nm, greater than or equal to 5 nm, greater than or equal to 10 nm, greater than or equal to 15 nm, greater than or equal to 20 nm, greater than or equal to 25 nm, greater than or equal to 30 nm, greater than or equal to 35 nm, greater than or equal to 40 nm, greater than or equal to 45 nm, greater than or equal to 50 nm, greater than or equal to 55 nm, greater than or equal to 60 nm, greater than or equal to 65 nm, greater than or equal to 70 nm, greater than or equal to 75 nm, greater than or equal to 80 nm, greater than or equal to 85 nm, greater than or equal to 90 nm, greater than or equal to 95 nm, greater than or equal to 100 nm, or greater than or equal to 500 nm. In some embodiments, islands, nanoparticles, or other nanoscale structures have an average arial diameter of less than or equal to 1000 nm, less than or equal to 500 nm, less than or equal to 100 nm, less than or equal to 95 nm, less than or equal to 90 nm, less than or equal to 85 nm, less than or equal to 80 nm, less than or equal to 75 nm, less than or equal to 70 nm, less than or equal to 65 nm, less than or equal to 60 nm, less than or equal to 55 nm, less than or equal to 50 nm, less than or equal to 45 nm, less than or equal to 40 nm, less than or equal to 35 nm, less than or equal to 30 nm, less than or equal to 25 nm, less than or equal to 20 nm, less than or equal to 15 nm, less than or equal to 10 nm, less than or equal to 5 nm, less than or equal to 2 nm, or less than or equal to 1 nm. For example, in some embodiments, the islands, nanoparticles, or other nanoscale structures have an average arial diameter of greater than or equal to 0.5 nm and less than or equal to 1000 nm. As another example, in some embodiments, the islands, nanoparticles, or other nanoscale structures have an average arial diameter of greater than or equal to 2 nm and less than or equal to 100 nm. In still another example, in some embodiments, the islands, nanoparticles, or other nanoscale structures have an average arial diameter of greater than or equal to 2 nm and less than or equal to 5 nm. Other ranges, both higher and lower than those described above, are also possible, as the disclosure is not so limited.

The islands, nanoparticles, or other nanoscale structures of an island-type membrane may cover any of a variety of appropriate proportions of the surface of the membrane. In some embodiments, islands, nanoparticles, or other nanoscale structures cover greater than or equal to 10%, greater than or equal to 20%, greater than or equal to 30%, greater than or equal to 40%, greater than or equal to 50%, greater than or equal to 55%, greater than or equal to 60%, greater than or equal to 65%, greater than or equal to 70%, greater than or equal to 75%, greater than or equal to 80%, greater than or equal to 85%, greater than or equal to 90%, greater than or equal to 95%, or greater than or equal to 99% of the area of the membrane. In some embodiments, islands, nanoparticles, or other nanoscale structures cover less than or equal to 100%, less than or equal to 99%, less than or equal to 95%, less than or equal to 90%, less than or equal to 85%, less than or equal to 80%, less than or equal to 75%, less than or equal to 70%, less than or equal to 65%, less than or equal to 60%, or less than or equal to 55% of the area of the membrane. Combinations of these ranges are also possible (e.g., greater than or equal to 10% and less than or equal to 100%, greater than or equal to 50% and less than or equal to 99%, or greater than or equal to 50% and less than or equal to 90%). Other ranges, both higher and lower than those described above, are also possible, as the disclosure is not so limited. In some embodiments, the plug-type membrane may include isolated inorganic (e.g., metallic) structures plugging pores in the porous support. The metal plugs may be isolated in the support pores so as to reduce the risk of metallic agglomeration at high temperatures. Of course, in some embodiments at least some of the plugs may be interconnected, as the disclosure is not so limited. The metal plugs block the pores of the porous support, urging gas molecules to pass through the metal plugs to flow across the membrane. The plugs may have various shapes, depending on the geometry of the support pores (since the support pores will constrain the metal plugs). In some embodiments, the metal plugs may be cylindrical. In other embodiments, the metal plugs may be lamellar. In yet other embodiments, the metal plugs may have aspect ratios close to 1. It should be appreciated that the metal plugs may be any suitable size or shape, as the present disclosure is not so limited.

In some embodiments of the plug-type membrane, the pores of the porous support may be isolated from one another. In other embodiments, the pores of the support may be shaped to trap the metal plugs and reduce the risk of their migration over time due to surface energy. For example, the pores of the porous support may be arranged in a linear, tortuous, networked, and/or any other suitable distribution. Often, the surface energy of the support material may be low compared to the surface energy of the metal, and the metal-surface material contact angle may be large (non-wetting). Accordingly, metal plugs may tend to migrate to regions of larger pore diameter, and the metal plugs will tend to get trapped in larger pore voids. The pores may be cylindrical, in which case the metal plugs may not have a driving force to migrate, but may still experience a force to hold them in place relative to the pores of the support. The metal plugs may be located near one of the surfaces of the porous support, or may be located in the interior of the porous support. The pores of the porous support may be designed with a gradient in pore size to preferentially trap the metal islands in a thermally-stable state. In some embodiments, an intermediate layer of atomically thin material may be added to this membrane to modify the membrane performance.

The hydrogen selective materials of the membranes of the present disclosure, which may in in the form of microstructures (e.g., islands, plugs) and/or conformal layers, may be formed using any suitable inorganic material known to adsorb hydrogen on the surface and/or in the bulk. Non-limiting, exemplary inorganic materials include palladium, niobium, vanadium, tantalum, zirconium, platinum, nickel, combinations thereof, and/or any other suitable material. Alloys of the aforementioned materials are also contemplated, including alloys of palladium, such as palladium silver, palladium gold, palladium copper, palladium yttrium, palladium nickel, palladium cerium, palladium gadolinium, palladium gadolinium silver, palladium yttrium silver, combinations thereof, and/or any other suitable alloy which may or may not include palladium. In some embodiments, adhesion-promoting metals including, but not limited to titanium, indium, and chromium may be added or coated onto surfaces of the support. It should be appreciated that any suitable material or combination of materials capable of adsorbing or selectively transporting hydrogen on the surface and/or in the bulk, (including, but not limited to, zeolites, metal-organic frameworks, covalent organic frameworks, polymers, combinations thereof, etc.) may also be employed.

It should, of course, be understood that any of the above-mentioned hydrogen-selective materials may be used in a context where hydrogen selectivity of the hydrogen selective material is the dominant mechanism of hydrogen transport across the membrane. It should also be understood that, in some embodiments, any of the above-mentioned hydrogen selective materials may be used as a simple barrier, and that hydrogen selectivity of the membrane could result from another hydrogen selection mechanism, such as size exclusion, as described elsewhere herein. In such contexts, either a hydrogen selective material as described above, or another, non-hydrogen-selective material, or both may be used, depending on the embodiment, since the material may simply act as a barrier to gas transport through large pores of the membrane. Thus, it should be understood that any of the embodiments of membranes disclosed herein may include selective structures formed on an underlying atomically thin layer using hydrogen selective and/or non-hydrogen-selective materials depending on the desired application. A few, non-limiting examples of non-hydrogen-selective materials that could be used to form islands, nanoparticles, or other nanoscale structures include, but are not limited to, carbon, silicon, fullerene, carbon nanotubes, flakes of atomically thin materials, metals (e.g., gold, silver, copper, aluminum, chromium, titanium, other noble metals, etc.), metal oxides, or metal nitride (e.g., Ti, Cr, Aluminum oxide, Hafnium oxide, Aluminum nitride, Hafnium nitride), ceramics (e.g., silicon carbide, boron nitride, silica, silicon nitride, titanium carbide, zirconia, yttria, etc.), salts (sodium chloride, calcium sulfate, copper chloride, calcium carbonate, etc.), hydrocarbons (wax, alkanes, aromatic compounds), polymers (polymethyl methacrylate, polyethylene, polystyrene, polycarbonate), or biomolecules (proteins, peptides, nucleic acids, etc.).

As used herein, an “atomically thin layer” refers to a structure formed from one or more planar atomic layers of materials. Atomically thin layers, also known as two-dimensional monolayers or two-dimensional topological materials, are crystalline materials composed of a single layer of atoms. For example, a layer of graphene is typically a one atom thick allotrope of carbon, though multiple layers may also be present. Without wishing to be bound by theory, atomically thin materials typically have strong chemical bonds within a plane or layer, but have relatively weaker bonds out of the plane with neighboring planes or layers. Therefore, atomically thin materials typically form sheets of material that may be a single atom thick, i.e. monolayer sheets, to thicker sheets that include several adjacent planes of atoms. For example, an atomically thin layer and/or material may be considered to be a sheet or layer of material including one or more adjacent crystal planes extending parallel to a face of the sheet or layer. An atomically thin material may have a thickness corresponding to any appropriate number of crystal planes including sheets with a thickness corresponding to 1 atomic layer, or in some instances, a thickness that is less than or equal to 2, 3, 4, 5, or 10 atomic layers, or any other appropriate number of atomic layers. Further, depending on the particular type of atomically thin layer and/or material being used, an atomically thin layer may have a thickness between 0.1 nm and 10 nm, between 0.3 nm and 5 nm, or between 0.345 nm and 2 nm. The theoretical thickness of a sheet of graphene is 0.345 nm, and so an atomically thin layer comprising a single layer of graphene would be expected to have a thickness of approximately 0.345 nm. However, ranges both larger and smaller than those noted above are also contemplated as the disclosure is not so limited. Atomically thin materials may also be referred to as ultra-strength materials and/or two-dimensional materials as well.

In embodiments where an atomically thin layer comprises multiple atomically thin layers, layers may be stacked on one another and/or layers may be bonded to adjacent layers. In embodiments employing multiple atomically thin layers, the lattice of one layer may or may not be registered and/or aligned to the lattice of another layer. In some cases, when multiple atomically thin layers are grown, they may be bonded to one another as a result of the formation process. In some embodiments, defects in one or more atomically thin layers may be blocked by other atomically thin layers. It should be appreciated that in some embodiments, the multiple atomically thin layers may be formed of the same material, whereas in other embodiments, the multiple atomically thin layers may be formed of different materials. These dimensions of an atomically thin layer have particular importance in performing the filtration techniques described herein, since in large part it is the thin nature of these materials that allow high permeance and high flow rates while maintaining better selectivity as compared to polymeric membranes.

For the sake of clarity, the embodiments and examples described below are primarily directed to the use of graphene. For example, the atomically thin material may be a layer of graphene, which is a one atom thick allotrope of carbon. However, the methods and membranes described herein are not so limited. For example, appropriate atomically thin materials that may be used to form an atomically thin layer include, but are not limited to, hexagonal boron nitride, molybdenum sulfide, vanadium pentoxide, silicon, doped-graphene, graphene oxide, hydrogenated graphene, fluorinated graphene, covalent organic frameworks, layered transition metal dichalcogenides (e.g., MoS₂, TiS₂, etc.), two dimensional oxides (e.g., graphene oxide, NiO₂, etc.), layered Group-IV and Group-Ill metal chalcogenides (e.g., SnS, PbS, GeS, etc.), silicene, germanene, and layered binary compounds of Group IV elements and Group III-V elements (e.g., SiC, GeC, SiGe), and any other appropriate atomically thin material. Other appropriate materials may include phosphorene and graphyne. Additionally, in some embodiments the methods described herein may be applied to the production of thicker non-atomically thin membrane materials such as graphene containing larger numbers of atomic layers, graphene oxide containing larger numbers of atomic layers, metal organic frameworks, thin-layer atomic layer deposition of metal oxides (AlO₂, HfO₂, etc.), zeolites, and other appropriate materials as well.

Any of the atomically thin materials of the present disclosure may have any suitable porosity and pore size. In some embodiments, the atomically thin materials may have a porosity greater than or equal to 0.01%, 0.1%, 1%, 2%, 5%, 10%, 20%, 50%, 60%, 70%, 80%, and/or any other suitable porosity. The atomically thin materials may also have a porosity less than or equal to 80%, 70%, 60%, 50%, 20%, 10%, 5%, 2%, 1%, 0.1%, 0.01% and/or any other suitable porosity. Combinations of the foregoing ranges, including atomically thin materials having porosities between 0.01% and 80% and between 0.01% and 0.1%, are also contemplated. In some embodiments, the atomically thin materials may not have pores, and hydrogen and/or hydrogen isotopes cross across the atomically thin layer(s) as protons. It should be appreciated that the atomically thin materials may have uniform or non-uniform porosities, such that the porosities described herein may refer to an average porosity. The average may be an average across an area of the atomically thin material, or across the entire atomically thin material, as the disclosure is not so limited. Of course, the atomically thin materials may have any suitable porosity, as the present disclosure is not so limited.

In some embodiments, the porosity of the atomically thin materials may be characterized by an average pore size, which may be any suitable size, such as greater than or equal to 0.1 nm, 0.3 nm, 1 nm, 2 nm, 3 nm, 5 nm, 10 nm, 50 nm, 100 nm, 200 nm, 500 nm, and/or any other suitable size. The pores of the atomically thin materials may also have an average pore size of less than or equal 500 nm, 200 nm, 100 nm, 50 nm, 10 nm, 5 nm, 3 nm, 2 nm, 1 nm, 0.3 nm, 0.1 nm, and/or any other suitable size. Combinations of the foregoing ranges, including pores of the atomically thin materials having an average pore size between 0.1 nm and 500 nm, and between 0.3 nm and 100 nm are also contemplated. In some embodiments, small average pore sizes (between several Angstroms and several nanometers) may enable deposition of ultrathin inorganic films with substantial surface coverage, and may provide a barrier against leakage of larger gas species. It should be appreciated that the atomically thin materials of the present disclosure may have any suitable size, shape, distribution, and arrangement, as the present disclosure is not so limited.

It should be appreciated that in any of the embodiments disclosed herein, any suitable combination of porosity of the inorganic material and porosity of the atomically thin materials may be employed to allow a hydrogen flow resistance of the atomically thin layer to be substantially similar to a hydrogen flow resistance of the inorganic material to enhance the permeance of the membrane.

The porous supports of the present disclosure may be formed of any suitable material, including, but not limited to, polymeric, inorganic, metallic, ceramic, silicon nitride, alumina, ceria, zirconia, hafnia, silicon carbide, titanium, polyethersulfone, polyvinyldifluoride, cellulose, combinations or composites thereof, and/or any or any other suitable material. In some embodiments, the porous supports are formed of silicon. It should be appreciated that any suitable material chemically and thermally stable at the operational temperatures (which may be greater than 600 K, or may, in some embodiments, be room temperature), may be employed. Generally, chemically and thermally stable support is desired, especially for high temperature operation. The permeance of the porous substrate to hydrogen may preferably be higher than the hydrogen permeance by an order of magnitude to mitigate leakage through any defects or damage to the film, but a wider range of permeances are also contemplated. In some embodiments, the porous support may be processed (e.g., annealed, polished) to help reduce the number of undesirable pores. In some embodiments, the porous support is made of materials that do not mix with the islands or plugs at high temperatures.

Any of the porous supports of the present disclosure may have any suitable porosity and pore size. In some embodiments, the porous support may have a porosity greater than or equal to 1%, 2%, 5%, 10%, 20%, 50%, 60%, 70%, 80%, and/or any other suitable porosity. The porous support may also have a porosity less than or equal to 80%, 70%, 60%, 50%, 20%, 10%, 5%, 2%, 1%, and/or any other suitable porosity. Combinations of the foregoing ranges, including porous supports having porosities between 1% and 80% and between 10% and 60%, are also contemplated. It should be appreciated that the porous supports may have uniform or non-uniform porosities, such that the porosities described herein may refer to an average porosity. Of course, the porous supports may have any suitable porosity, as the present disclosure is not so limited.

In some embodiments, the porosity of the porous support may be characterized by an average pore size, which may be any suitable size, such as greater than or equal to 0.5 nm, 1 nm, 2 nm, 3 nm, 5 nm, 10 nm, 50 nm, 100 nm, 200 nm, 500 nm, 1 μm, 5 μm, 10 μm, and/or any other suitable size. The pores of the porous support may also have an average pore size of less than or equal to 10 μm, 5 μm, 1 μm, 500 nm, 200 nm, 100 nm, 50 nm, 10 nm, 5 nm, 3 nm, 2 nm, 1 nm, and/or any other suitable size. Combinations of the foregoing ranges, including pores of the porous support having an average pore size between 0.5 nm and 10 μm, are also contemplated. In some embodiments, average pore sizes between 100 nm to 1 μm may be employed for the island-type membranes. In some embodiments, average pore sizes between 0.5 nm to 100 nm may be employed for the island-type membranes. For example, in some embodiments, average pore sizes between 10 nm to 100 nm or between 0.5 nm to 10 nm may be employed for the island-type membranes. In some embodiments, average pore sizes between 1 μm and 10 μm may be employed for plug-type membranes. According to some embodiments, average pore sizes between 10 nm and 1 μm may be employed for plug-type membranes. It should be appreciated that the porous supports of the present disclosure may have any suitable size, shape, distribution, and arrangement, as the present disclosure is not so limited.

It should be appreciated that any suitable fabrication method may be used to form the membranes of the present disclosure, including, but not limited to, electrochemical deposition, electroless deposition, chemical vapor deposition, sputtering, evaporation, atomic layer deposition, combinations thereof, and/or any other suitable method may be used to deposit the inorganic material (and/or any other portion of the membranes). For the film-type membranes, the deposition method and conditions such as the rate of deposition, temperature of deposition, and annealing may be used to control the film properties. In the case of deposition by sputtering, other sacrificial materials such as silica may be co-deposited and later removed to control film porosity and transport properties. In the case of island-type or plug-type membranes, the pores of the porous support (and/or the atomically thin material) may be functionalized to promote preferential deposition at the support pores. Other methods to fabricate plug-type membranes include, but are not limited to, electrochemical deposition, chemical vapor deposition, sputtering, evaporation, atomic layer deposition, particle coating and sintering, etc. Some of these processes may result in metal coatings that intrude into the support pores but also cover the surface. The surface layer may be removed by processes such as sputtering, polishing, or chemical etching to create membranes with isolated metal plugs only in the pores of the support. For example, the surface layer may be removed by chemical-mechanical polishing. Annealing may be performed to re-flow the metal plugs into a thermally-stable state. In addition, leakages, if any, may be blocked by deposition of material to block the leakage pathways.

Depending on the operational temperatures, it may be desirable to isolate the inorganic material (e.g., palladium or hydrogen-selective metal) from other materials which may diffuse into it and compromise selectivity, particularly in the plug-type membrane, where the metal is in direct contact with the support. In any of the embodiments described herein where the porous support is formed of a metallic material, a barrier coating material (e.g., oxide, graphene, hexagonal boron nitride, etc.) may be deposited in between the inorganic material and the porous support material to reduce the risk of diffusion. The barrier coating material may be deposited using any suitable method, including, but not limited to atomic layer deposition, chemical vapor deposition, electrochemical deposition, combinations thereof, among others.

In some embodiments, the membranes described herein may also be capable of catalytic processes for process intensification. In some embodiments, the inorganic material (e.g., metal) used for allowing selective flow of hydrogen may also serve as the catalyst. In other embodiments, one or more catalysts may be coated onto the same membrane, preferably not directly in contact with the hydrogen-selective metal. For example, in the plug-type membranes, the catalyst and the metal plugs may be separated by a porous layer deposited on top of a metal plug layer. In other embodiments, the catalyst may be deposited on the opposite side of the porous support layer. It should be appreciated that any suitable arrangement of catalyst and/or inorganic material may be employed, as the present disclosure is not so limited.

Any of the membranes described herein may be robust against radiation, which may cause damage or decay within the membrane, by including inorganic material with at least one dimension below 100 nm, which may induce the migration of defects to the surface. According to some embodiments, the membranes described herein are robust against radiation by including organic material with at least one dimension below 500 nm. In some embodiments, a membrane described herein is robust against helium entrapment due to decay of tritium, which may cause damage or decay within the membrane, by including organic material with at least one dimension below 500 nm (e.g., below 100 nm), which may induce the migration of defects to the surface.

The membranes of the present disclosure may employ materials, fabrication processes, configurations, and microstructures capable of operating at room temperature with minimal use of expensive metals. In embodiments where the membranes employ discrete islands or plugs, the membranes may be thermally stable at very high temperatures for prolonged operation, while still using minimal expensive metals. The usage of thin films and/or microstructures (e.g., islands and plugs) may reduce the materials cost by orders of magnitude, while also improving the performance. In comparison to conventional polymeric membranes, the membranes of the present disclosure may exhibit high permeance and good selectivity, exceeding the selectivity-permeability tradeoff of polymeric membranes. In some embodiments, the membranes of the present disclosure may operate at high temperatures beyond the range of operation of conventional membranes.

The membranes of the present disclosure may be employed in any suitable commercial application, including, but not limited to separation of hydrogen isotopes from each other and hydrogen isotopes from helium and other gases for nuclear fusion, hydrogen purification by methane reforming, photo-hydrolysis, electrolysis, methane cyclodehydrgenation, etc., process intensification by integration of catalytic reactions with hydrogen separation, separation of hydrogen and methane for natural gas purification, separation of hydrogen from carbon dioxide, and/or any other suitable application.

A membrane provided herein may be configured for operation at any of a variety of suitable temperatures. In some embodiments, a membrane is configured for operation at a temperature of greater than or equal to 275 K, greater than or equal to 300 K, greater than or equal to 325 K, greater than or equal to 350 K, greater than or equal to 375 K, greater than or equal to 400 K, greater than or equal to 425 K, greater than or equal to 450 K, greater than or equal to 475 K, greater than or equal to 500 K, greater than or equal to 525 K, greater than or equal to 550 K, greater than or equal to 575 K, greater than or equal to 600 K, greater than or equal to 625 K, greater than or equal to 650 K, greater than or equal to 675 K, greater than or equal to 700 K, greater than or equal to 725 K, greater than or equal to 750 K, greater than or equal to 775 K, greater than or equal to 800 K, greater than or equal to 825 K, greater than or equal to 850 K, greater than or equal to 875 K, greater than or equal to 900 K, greater than or equal to 925 K, greater than or equal to 950 K, greater than or equal to 975 K, greater than or equal to 1000 K, greater than or equal to 1200 K, greater than or equal to 1500 K, or greater than or equal to 1800 K. In some embodiments, a membrane is configured for operation at a temperature of less than or equal to 2000 K, less than or equal to 1800 K, less than or equal to 1500 K, less than or equal to 1200 K, less than or equal to 1000 K, less than or equal to 975 K, less than or equal to 950 K, less than or equal to 925 K, less than or equal to 900 K, less than or equal to 875 K, less than or equal to 850 K, less than or equal to 825 K, less than or equal to 800 K, less than or equal to 775 K, less than or equal to 750 K, less than or equal to 725 K, less than or equal to 700 K, less than or equal to 675 K, less than or equal to 650 K, less than or equal to 625 K, less than or equal to 600 K, less than or equal to 575 K, less than or equal to 550 K, less than or equal to 525 K, less than or equal to 500 K, less than or equal to 475 K, less than or equal to 450 K, less than or equal to 425 K, less than or equal to 400 K, less than or equal to 375 K, less than or equal to 350 K, less than or equal to 325 K, or less than or equal to 300 K.

Combinations of these ranges are also possible (e.g., greater than or equal to 275 K and less than or equal to 2000 K, greater than or equal to 300 K and less than or equal to 1000 K, or greater than or equal to 600 K and less than or equal to 1000 K). Other ranges, both higher and lower than those described above, are also possible, as the disclosure is not so limited. In some embodiments, the plugs or islands are solid when the membrane is operated. In some embodiments, the plugs or islands may be liquid when the membrane is operated.

A membrane provided herein may provide any of a variety of hydrogen permeances at one of the above-mentioned temperatures of operation. In some embodiments, the membrane has a hydrogen permeance of greater than or equal to 1×10⁻⁹ mol/m2·s·Pa, greater than or equal to 1×10⁻⁸ mol/m2·s·Pa, greater than or equal to 5×10⁻⁸ mol/m2·s·Pa, greater than or equal to 1×10⁻⁷ mol/m2·s·Pa, greater than or equal to 5×10⁻⁷ mol/m2·s·Pa, greater than or equal to 1×10⁻⁶ mol/m2·s·Pa, greater than or equal to 5×10⁻⁶ mol/m2·s·Pa, or greater at an aforementioned temperature. In some embodiments, the membrane has a hydrogen permeance of less than or equal to 1×10⁵ mol/m2·s·Pa, less than or equal to 5×10⁻⁶ mol/m2·s·Pa, less than or equal to 1×10⁻⁶ mol/m2·s·Pa, less than or equal to 5×10⁻⁷ mol/m2·s·Pa, less than or equal to 1×10⁻⁷ mol/m2·s·Pa, less than or equal to 5×10⁻⁸ mol/m2·s·Pa, less than or equal to 1×108 mol/m2·s·Pa, or less at an aforementioned temperature. Combinations of these ranges are also possible (e.g., greater than or equal to 1×10⁻⁹ mol/m2·s·Pa and less than or equal to 1×10⁻⁵ mol/m2·s·Pa at an aforementioned temperature). For example, in some embodiments, a membrane provided herein has one of the aforementioned permeances at 300 K, 500 K, 700 K, or 900 K. Other ranges, both higher and lower than those described above, are also possible, as the disclosure is not so limited.

A membrane provided herein may provide any of a variety of suitable hydrogen/helium selectivity values (defined as the ratio of hydrogen permeance to helium permeance) at one of the above-mentioned temperatures of operation. In some embodiments, a membrane provided herein has a hydrogen/helium selectivity of greater than or equal to 2, greater than or equal to 3, greater than or equal to 4, greater than or equal to 5, greater than or equal to 6, greater than or equal to 7, greater than or equal to 8, greater than or equal to 9, greater than or equal to 10, greater than or equal to 11, greater than or equal to 12, greater than or equal to 13, greater than or equal to 14, greater than or equal to 15, greater than or equal to 16, greater than or equal to 17, greater than or equal to 18, greater than or equal to 19, greater than or equal to 20, greater than or equal to 50, greater than or equal to 100, greater than or equal to 150, greater than or equal to 200, greater than or equal to 250, greater than or equal to 300, greater than or equal to 350, greater than or equal to 400, greater than or equal to 450, greater than or equal to 500, greater than or equal to 550, greater than or equal to 600, greater than or equal to 650, greater than or equal to 700, greater than or equal to 750, greater than or equal to 800, greater than or equal to 850, greater than or equal to 900, or greater than or equal to 950 at an aforementioned temperature. In some embodiments, a membrane provided herein has a hydrogen/helium selectivity of less than or equal to 1000, less than or equal to 950, less than or equal to 900, less than or equal to 850, less than or equal to 800, less than or equal to 750, less than or equal to 700, less than or equal to 650, less than or equal to 600, less than or equal to 550, less than or equal to 500, less than or equal to 450, less than or equal to 400, less than or equal to 350, less than or equal to 300, less than or equal to 250, less than or equal to 200, less than or equal to 150, less than or equal to 100, less than or equal to 50, less than or equal to 20, less than or equal to 19, less than or equal to 18, less than or equal to 17, less than or equal to 16, less than or equal to 15, less than or equal to 14, less than or equal to 13, less than or equal to 12, less than or equal to 11, less than or equal to 10, less than or equal to 9, less than or equal to 8, less than or equal to 7, less than or equal to 6, less than or equal to 5, less than or equal to 4, or less than or equal to 3 at an aforementioned temperature. Combinations of these ranges are also possible (e.g., greater than or equal to 2 and less than or equal to 1000, greater than or equal to 2 and less than or equal to 100, greater than or equal to 2 and less than or equal to 20, or greater than or equal to 2 and less than or equal to 10 at an aforementioned temperature). For example, in some embodiments, a membrane provided herein has one of the aforementioned hydrogen/helium selectivity at 300 K, 500 K, 700 K, or 900 K. Other ranges, both higher and lower than those described above, are also possible, as the disclosure is not so limited.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

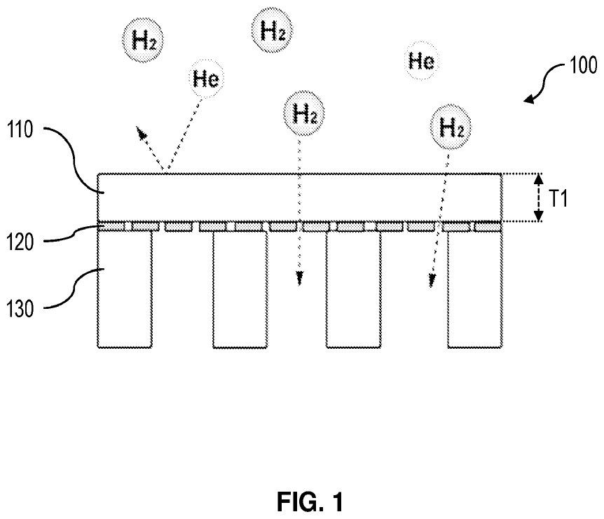

FIG. 1 shows a membrane 100 according to some embodiments. The membrane 100 includes a conformal film 110, which may be formed of a porous metal, arranged on an atomically thin layer 120, both arranged on a porous support 130. In some embodiments, the film 110 may be a palladium-based material, the atomically thin layer 120 may be a 2D material such as graphene, and the porous support may be formed of anodized aluminum oxide. As shown in FIG. 1, the combination of the various layers may allow a material, such as hydrogen (H₂) or deuterium, to pass through, while greatly limiting the passage of other materials, such as helium (He), as shown.

In some embodiments, the layer 120 may serve as a barrier layer between the film 110 and the support 130. For example, the atomically thin layer 120 may reduce the risk of diffusion between the film 110, which may be formed of an inorganic material, and the support 130, which may be formed of a metallic oxide.

In some embodiments, the presence of layer 120 may enable a more uniform film 110 due to the adhesion between the two layers (e.g., graphene and palladium, respectively). This adhesion may also reduce the risks associated with the exposure of film 110 (which may be formed of palladium) to hydrogen, which may otherwise induce phase changes and strain during cycles of exposure to hydrogen, which may in turn, increase the risks of damage to the membrane. It should be appreciated that other benefits associated with the presence of the atomically thin layer 120 are also contemplated.

As shown in FIG. 1, the film 110 has a thickness T1 which may be large enough to have a suitable permeance, and small enough to avoid limitations in selectivity, as discussed earlier. Accordingly, the film 110 may have any suitable thickness, including, but not limited to, between 20 and 200 nm. In some embodiments, the film 110 thickness T1 may be greater than or equal to 10 nm, 20 nm, 30 nm, 50 nm, 70 nm, 100 nm, 120 nm, 150 nm, 180 nm, 200 nm, 250 nm, 300 nm, 350 nm, 400 nm, 450 nm, 500 nm, and/or any other suitable thickness. The film 110 thickness T1 may also be less than or equal to 500 nm, 450 nm, 400 nm, 350 nm, 300 nm, 250 nm, 200 nm, 180 nm, 150 nm, 120 nm, 100 nm, 70 nm, 50 nm, 30 nm, 20 nm, 10 nm, and/or any other suitable thickness. Combinations of the foregoing ranges, including between 50 nm and 200 nm, between 20 nm and 200 nm, and/or any other suitable ranges, are also contemplated. In some embodiments, an inorganic film thickness below 100 nm may induce the migration of defects to the surface of the film, rather than the bulk, which may reduce the risk of leaks. In some embodiments, a film thickness greater than 500 nm may result in undesirable lamination effects, which may allow non-hydrogen materials to pass through the membrane. However, it should be appreciated that the film 110 thickness T1 may have any suitable thickness (above and below 500 nm, for alternative applications), as the present disclosure is not so limited.

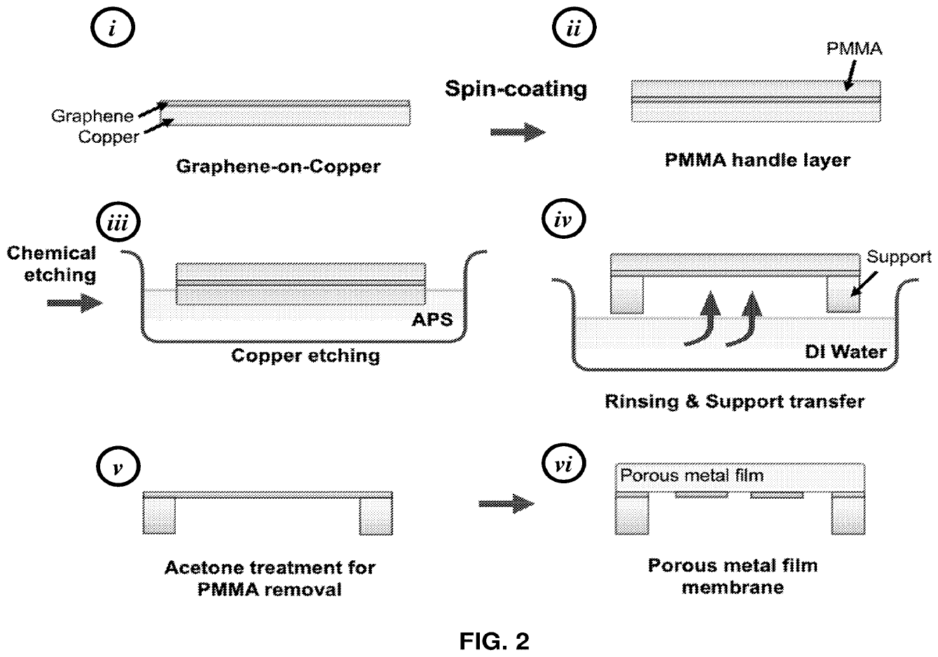

FIG. 2 shows an exemplary fabrication process for membrane 100 of FIG. 1. The fabrication process can be generally divided into two steps, one including the transfer of the atomically thin layer (e.g., graphene) and one including the deposition of the porous inorganic film. The process for the atomically thin layer transfer may begin by first preparing a clean graphene-on-copper foil, as shown in step (i) of FIG. 2. In some embodiments, the foil may have a surface of approximately 1 cm×1 cm. In step (ii), two polymethylmethacrylate (“PMMA”) layers having different molecular weights may be coated on the foil using a spin coater. For example, a low molecular weight PMMA layer may be coated first on the graphene layer followed by the coating of the PMMA with high molecular weight, so that PMMA can be removed easily from the surface with less residue on the graphene layer. In step (iii), the copper foil may be chemically and selectively etched using a copper etchant (e.g., Ammonium persulfate; APS). In step (iv), the membrane may be rinsed and scooped out using a porous support (e.g., anodic aluminum oxide (“AAO”)). Depending on the surface roughness of the porous support, surface polishing may be included for better graphene coverage. Following thorough drying of the membrane, PMMA layer may be removed using an acetone bath, as shown in step (v) of FIG. 2.

In some embodiments, the atomically thin layer may undergo a process to generate pores. For example, oxygen plasma may be used to create pores on the atomically thin (e.g., graphene) layer. The pores may be formed using any suitable method, including, but not limited to, focused ion beam followed by chemical etching (e.g. KMnO4 etching) or oxygen plasma. In some embodiments, the pores may be formed by ozone-based etching. It should be appreciated that non-modified atomically thin layers are also contemplated, as the present disclosure is not limited by the porosity of the atomically thin layer.

In particular, without wishing to be bound by any particular theory, in some embodiments protons (or nuclei of hydrogen isotopes) and electrons, and by extension hydrogen atoms (which can dissociate into protons and electrons), can pass through some atomically-thin materials including graphene and hexagonal boron nitride. According to some embodiments, and without wishing to be bound by any particular theory, vacancy defects or gas-impermeable pores in atomically thin materials can further assist selective transport of protons over gases. Without wishing to be bound by any particular theory, in some embodiments hydrogen selective materials such as palladium may dissociate hydrogen molecules into hydrogen atoms. Thus, according to some embodiments, membranes comprising a hydrogen-selective material disposed on one or both sides of an atomically-thin material, as described herein, may be useful for the preparation of hydrogen-selective membranes. In some embodiments, a membrane may be used to dissociate hydrogen atoms using the hydrogen selective material (e.g., in the form of islands or plugs) to form protons (or other hydrogen nuclei) and electrons, to transport the protons (or other hydrogen nuclei through the atomically thin layer as protons (or other hydrogen nuclei) and electrons, and to recombine the protons (or other hydrogen nuclei) and electrons to form hydrogen gas on an opposite side of the membrane. Without wishing to be bound by any particular theory, gases other than hydrogen isotopes may be largely blocked from passage across the membrane due to the atomically thin layers and the nanostructures. It should, of course, be understood that other embodiments are also possible, as the disclosure is not so limited.

In some embodiments, the film, which may be a porous inorganic material (e.g., palladium), may be deposited on the porous atomically thin layer using an electron beam evaporator, as shown in step (vi) of FIG. 2. This deposition method may result in a generally low density of the film with high porosity due to the low energy of the adatoms. To change the porosity of the film, the deposition rate or vacuum pressure of the evaporator may be adjusted. It should be appreciated that different deposition methods, such as sputtering or atomic layer deposition, may also be employed to increase the porosity of the film.

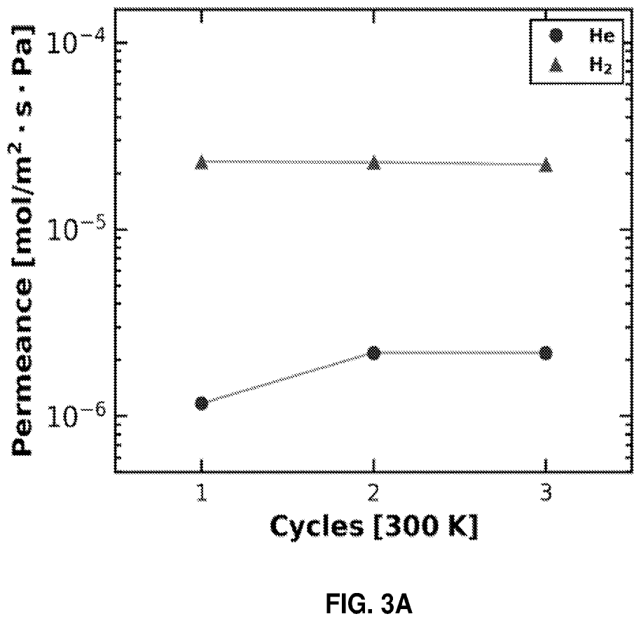

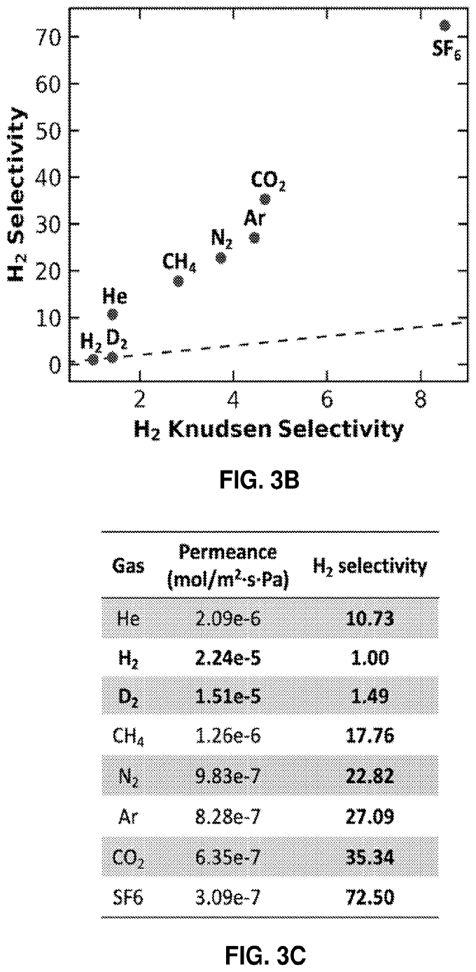

The performance of membranes employing porous inorganic films, which may be represented by FIG. 1, may be evaluated by measuring permeance and hydrogen selectivity against other gas species at room temperature (˜300 K). First, the permeance to hydrogen and helium may be measured repeatedly until the values reach a steady state. FIG. 3A shows an exemplary measurement of helium and hydrogen permeance on a membrane with a 200 nm porous palladium film. As shown, after the first cycle, the permeance to helium nearby doubles, possibly due to the phase change of the palladium film, causing the volumetric expansion and the subsequent creation of both nano-scale gaps and bulging of the film. Without wishing to be bound by theory, under the hydrogen environment, palladium may undergo phase transition from alpha phase to beta at low temperature (<300 K), due to the absorption of the hydrogen going into the lattice sites, resulting in the expansion of the lattice parameter from 0.389 nm to 0.403 nm. The expansion of volume may create cracks or gaps. After this deformation, however, membrane permeance may become stable, indicating that the phase change of porous inorganic film only affects the initial performance, as suggested by FIG. 3A.

FIG. 3B shows another performance metric measurement of a membrane with a 200 nm porous palladium film. The figure depicts the single-gas membrane permeance using several gas species, exhibiting distinct permeances to hydrogen compared to other gas components, resulting in much higher hydrogen selectivity than Knudsen selectivity, which represents the theoretical selectivity that a porous membrane can have under the Knudsen effusion regime. Without wishing to be bound by theory, Knudsen selectivity is a theoretical estimation of the selectivity with the assumption that the gas transport is governed by Knudsen effusion. For example, hydrogen Knudsen selectivity against methane is calculated by the square root of the molar weight ratio; (molar weight of hydrogen/molar weight of methane).

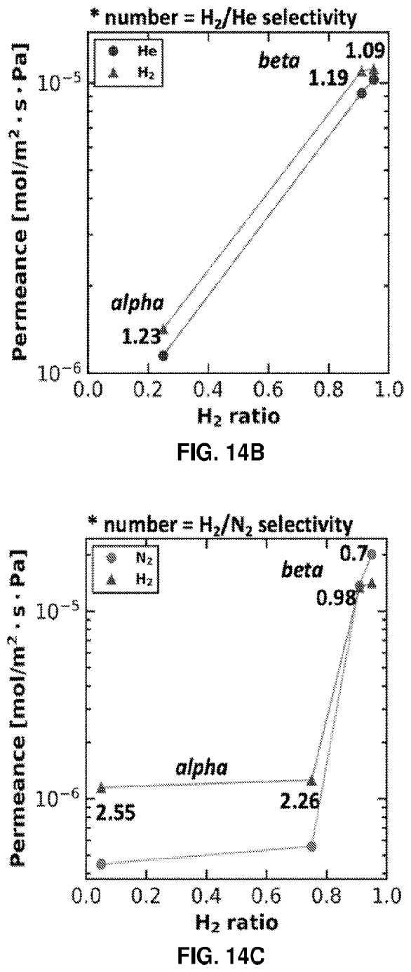

The selectivity shown in FIG. 3B may be attributed to the novel configuration of the porous inorganic film membrane. As described previously, there may be three major transport mechanisms for explaining hydrogen transport in porous inorganic film layer: 1) molecular diffusion through the void, 2) surface diffusion of hydrogen molecule or atoms along the inorganic surface, and 3) transport through the palladium lattice by solution-diffusion mechanism. These multiple pathways facilitate the overall transfer rate of the hydrogen across the inorganic film, enabling high permeance. Other gas species, on the other hand, only have one primary pathway (transport via null space), which increases the overall flow resistance and decreases the permeance accordingly. Alternatively, surface diffusion may occur via hydrogen molecules or atoms intercalating between the inorganic and the graphene layer, such that hydrogen passes through the metal layer or defects within the inorganic layer, then along the interface between the inorganic and graphene, and out through the pores in the graphene layer. Mixed-gas experiments discussed herein (see FIG. 14, below) indicate that in at least some cases, mechanism (1) was dominant.

FIG. 3C is a table of exemplary measured permeance and selectivity of a 200 nm porous palladium film membrane to various gas species, the data from which is depicted partially in FIGS. 3A-3B.

The performance of film-type membranes may also be evaluated based on the comparison with other types of hydrogen selective membranes using Robeson plots. It should be appreciated that porous inorganic film membranes outperform the general performance of conventional polymeric membranes in selectivity of methane, nitrogen, and carbon dioxide vs. permeability of hydrogen, which can be calculated by permeance times the thickness of the film (e.g., 200 nm).

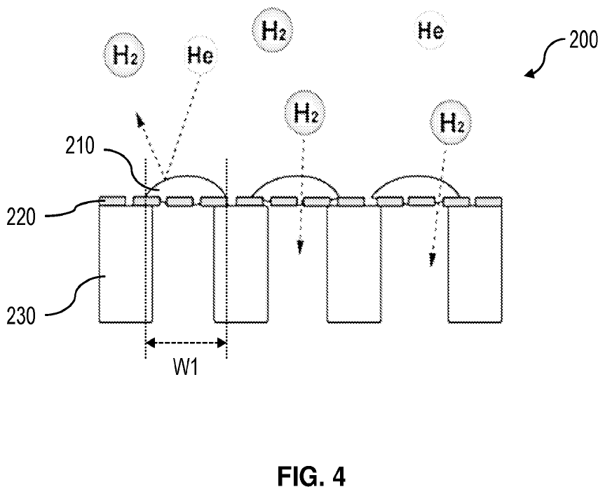

FIG. 4 shows another embodiment of a membrane 200, employing inorganic islands 210 distributed on top of an atomically thin layer 220, both of which may be situated on a porous support 230. As described previously, the atomically thin layer 220 may be graphene, and the porous support may be formed of AAO. As shown in the figure, the inorganic islands 210 may be at least partially aligned with the pores of the porous substrate 230, given that the pore edges may have the lowest surface energy.

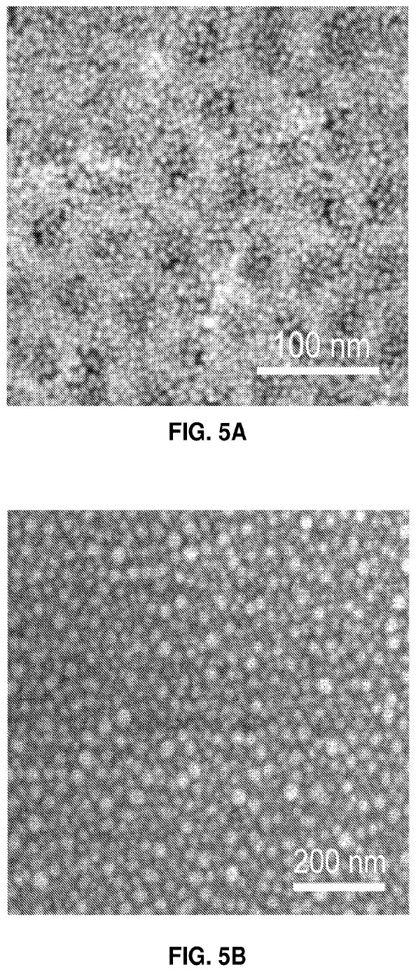

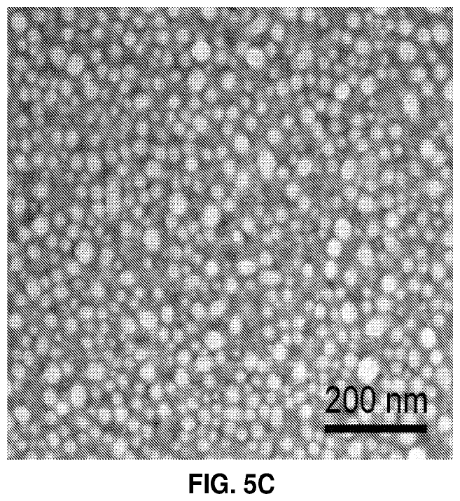

The process of fabricating the membrane 200 may be initially similar to that described in relation to membrane 100 above. In particular, the atomically thin layer 220 transfer to the porous substrate 230 may be similar. Following the transfer, a process (e.g., oxygen plasma) may be optionally employed to form pores on the atomically thin layer (e.g., graphene), followed by a coating of a very thin inorganic (a few nanometers) using an electron beam evaporator. FIG. 5A shows an SEM image of a 2 nm palladium layer partially covering an atomically thin layer. The partial nature of the coverage may be due at least in part to its extremely thin thickness.

To form islands, heat treatment may be employed to allow the inorganic adatoms to diffuse and aggregate, forming island or particle structures. Unlike the as-deposited palladium layer, larger palladium islands with low density may be observed due to the metallic agglomeration after a single cycle of treatment. This low density of palladium islands may deteriorate the membrane performance, especially selectivity, due to the exposed graphene pores through which helium can permeate. To increase the island density, palladium deposition and annealing steps (1 cycle, consisting of palladium deposition followed by annealing in argon at 1000 K for 12 hours) may be repeated. Depending on the embodiment, however, use of a single cycle may suffice. For example, use of a single cycle may be appropriate for forming islands to be used at relatively low temperatures (e.g., around 300 K), where thermal dewetting of the palladium islands is unlikely to occur. FIG. 5B shows the membrane following three cycles of annealing at 1000 K for 12 hours. It should be appreciated that repeating the cycles may increase the density of the islands, and three cycles seem to sufficiently cover most of the graphene surface. Notably, the deposition of palladium islands on porous graphene membranes resulted in much lower permeance to gases compared to porous graphene membranes without the palladium islands as shown in Table 1, indicating that the palladium islands blocked flow through the pores in graphene.

TABLE 1
Permeances, coverage, and selectivity
of palladium island membrane at 300 K.

| Property | No Pd | 1 Cycle | 3 Cycles |
|---|---|---|---|
| He Permeance (mol/m²-s-Pa) | 1.14 × 10⁻⁵ | 7.94 × 10⁻⁶ | 4.51 × 10⁻⁷ |
| Overall Coverage | 92.6% | 94.8% | 99.7% |
| He/H₂ Selectivity | 0.75 | 0.82 | 1.10 |
| He/D₂ Selectivity | 1.05 | 1.12 | 1.99 |

In some embodiments, the islands may be formed using a patterning process, although embodiments formed using a patterning process and a thermal cycling process are also contemplated.

The Inventors have recognized that reducing the thickness of film-type membranes (such as those represented by FIG. 1) to reduce material cost and enhance overall performance, may result instability at high temperatures (>600 K) due to metallic agglomeration, deforming the film in a way that reduces the exposed surface area. The island-type membranes represented by FIG. 4 may have the added benefit of effectively decreasing the thickness of the inorganic layer while retaining thermal stability at high temperatures since the hemispherical inorganic islands are already at their minimized surface area. FIG. 5C shows palladium islands following exposure to 1000 K for 100 hours, which do not exhibit significant change in comparison to FIG. 5B, suggesting that the island-type membrane may be highly stable at high temperatures for prolonged periods of time. Moreover, the estimated permeance to hydrogen for the island-type membranes may be in the range of 10⁻⁵ mol/m²·s·Pa at 800 K, which may be at least 100 times higher than the film-type membranes having a film thickness of a few micrometers. In some embodiments, the island-type architecture may block 98-99% of flow through the membrane.

It should be appreciated that the islands (see islands 210 in FIG. 4) may be isolated from one another. As shown in FIG. 4, the islands 210 may have an average size W1 of any suitable size. In some embodiments, the average width W1 of the islands may range from a single atom to hundreds of nanometers. The average width W1 of the islands may range between 1 nm and 100 nm, between 2 nm and 20 nm, between 5 nm and 10 nm, between 1 nm and 20 nm, combinations thereof, and/or any other suitable size. In some embodiments, islands having an average width W1 less than 50 nm may have improved stability, reduced cost (due to size), and enhanced permeance. It should be appreciated that any size and/or shape island may be employed in the membranes herein, as the present disclosure is not so limited.

The isolated islands (or any other isolated microstructures) may have any suitable shape, including the semi-hemispherical shapes shown in FIG. 4. In some embodiments, the height of the islands may be substantially equivalent to the average width W1 of the islands. Of course, various surface energies employed may result in islands with aspect ratios below and above 1, as the present disclosure is not so limited.

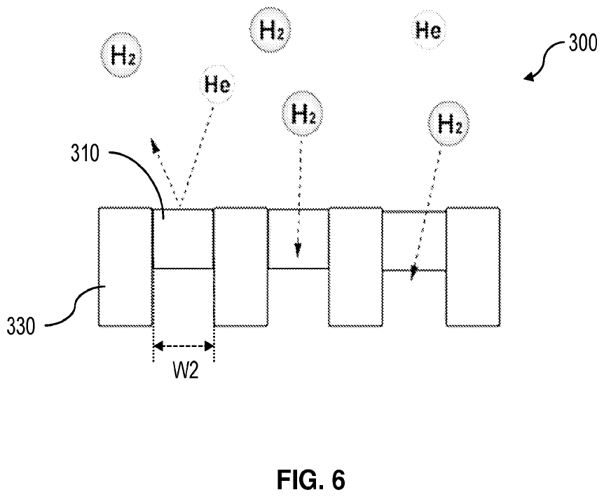

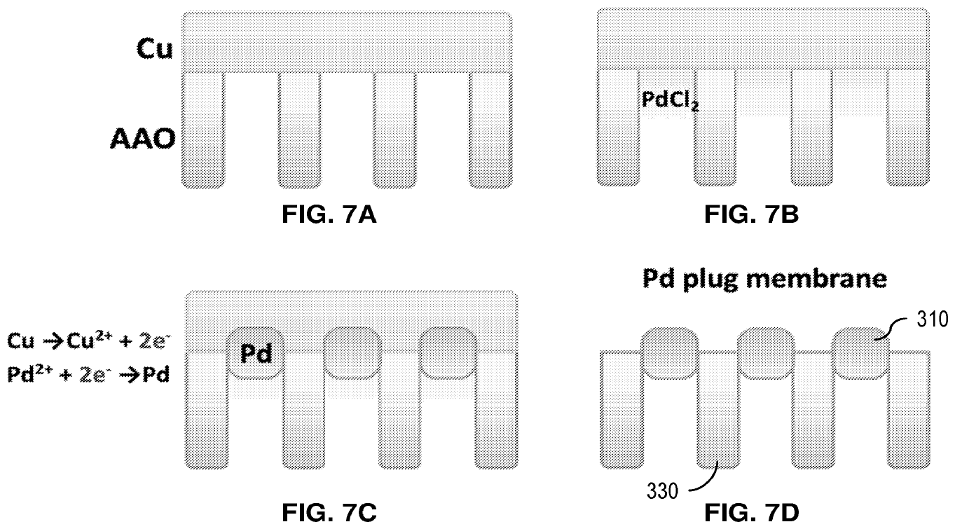

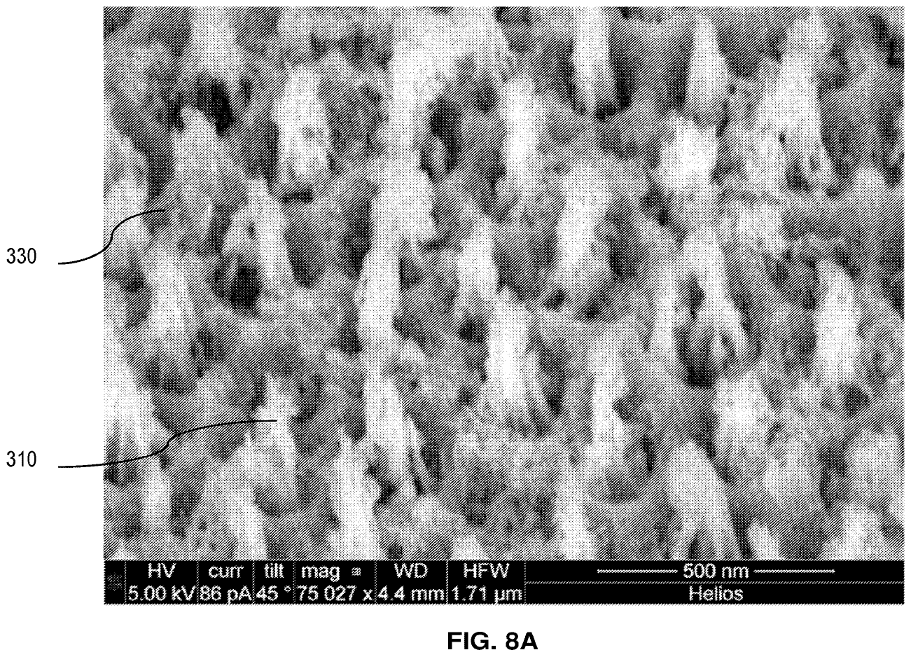

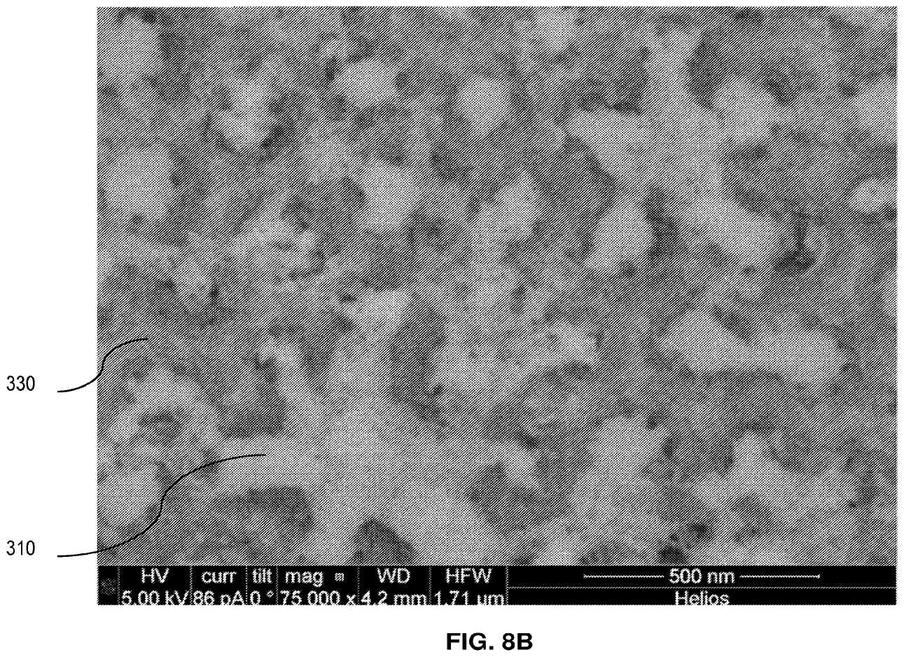

FIG. 6 shows yet another embodiment of a membrane 300 having isolated plugs 310 arranged within the pores of a porous substrate 330. The plugs 310, which may be formed of an inorganic (e.g., palladium) material, may be isolated within the pores of the support. FIG. 7 shows an exemplary process of forming said plugs using a galvanic displacement reaction (GDR). As shown in FIG. 7A, first, a sacrificial layer may be deposited on the porous support. It should be appreciated that although the sacrificial layer is labeled as copper in FIG. 7A, any other metal or material with a lower electrochemical potential than the material of the plugs may be employed. The thickness of the sacrificial layer may be tuned as long as the layer covers the entire porous support without defects. In FIG. 7B, after the deposition, the diffusion cell may be filled with the solutions having metal-ion solute (e.g., palladiumCl₂). For example, 5 mM palladiumCl₂ with 0.1 g of NaCl in 40 mL deionized water may be used. The coated porous support may be mounted in a way that only the opposite side of the sacrificial film is exposed to the solution, as shown in FIG. 7B. Due to the difference in redox potential between sacrificial film and the metal ions in the solution, the spontaneous reaction in the interfacial region occurs, which is referred to as galvanic displacement reaction. As shown in FIG. 7C, the oxidation of the sacrificial layer (copper) produces copper ions and electrons, which may be simultaneously involved in the reduction of the metal ions (palladium ion), creating palladium plugs at the interface between the copper film and the liquid solution. After 4 to 6 hours, the membrane may be rinsed and immersed into a copper etchant (e.g., APS) to remove the copper residue on the surface, as shown in FIG. 7D, followed by thorough rinsing and drying in air. SEM images shown in FIGS. 8A-8B depict the metallic plugs sealing the pores of the porous support. It should be appreciated that the material of the plug is not limited to a single metal species, but it could be an alloy, depending on the materials used in GDR. In some embodiments, characterization of the metal plug membrane using EDX may reveal that the plug may be mainly formed of two materials; palladium and copper, indicating that the metal plug can be an alloy.

It should be appreciated that other means of fabrication of metal plug membranes may be also employed. For example, metal particles may be incorporated into a sintering-based or sol-gel-based process to fabricate the support. Such processes are often used to prepare ceramic membranes. The pore size can be controlled using various factors, such as size of the particles in the case of sintering, and gradients of pore sizes can be produced. When metal particles are added during such processes, porous membranes with embedded metal particles may be formed.

In some embodiments, plug-type membranes may be formed with an electroplating process. For example, a membrane with isolated cylindrical pores (e.g. ceramic membrane such as anodized alumina) may be coated with a metal layer (e.g., copper), followed by electroplating of hydrogen-selective metal (e.g. palladium or palladium alloy). The copper may then be etched away by a selective etchant, leaving the palladium in the membrane pores. To embed palladium plugs inside the pores at a controlled depth, copper may first be electroplated to a desired depth, followed by electroplating of palladium. This may deposit palladium further inside the pores and make it less likely to exit the pores. The membrane pores may be made narrower at the ends to present a thermodynamic energy barrier, such that it may be energetically unfavorable for the metal plugs to exit the pores. This may be achieved in a variety of ways, including etching (such methods are used to make bullet-shaped track etched membrane pores), coating of material preferentially at the pore ends using processes such as sputtering, atomic layer deposition, physical or chemical vapor deposition, etc., or other methods. The coating material may be the same or different from the membrane material. Deposition of material on the surface of the membrane or at the pore ends with less favorable interaction with the inorganic material may also make it more energetically unfavorable for the metal to exit the pores. Deposition of material to narrow the pore ends may be done before or after deposition of the metal. In addition, atomic layer deposition, etching, or other processes may be used to make the cross-section of the membrane pores closer to circular. A circular cross-section will ensure that the contact between the metal plug and the pore walls is maintained at a circumference of the pores such that there is no leakage of gases through gaps between the membrane pore and the metal plug. The geometry of the pores may result in a more energetically favorable state for the metal to contact the pore surface at least at one continuous curve which divides the pore wall surface into an upstream region and a downstream region, with little to no leakage of gases from the upstream region side to the downstream region side via gaps between the metal plug and the pore walls. In some embodiments, surface coatings or additives that enhance adhesion between the metal plug and the membrane pores may be employed to mitigate the formation of such gaps.

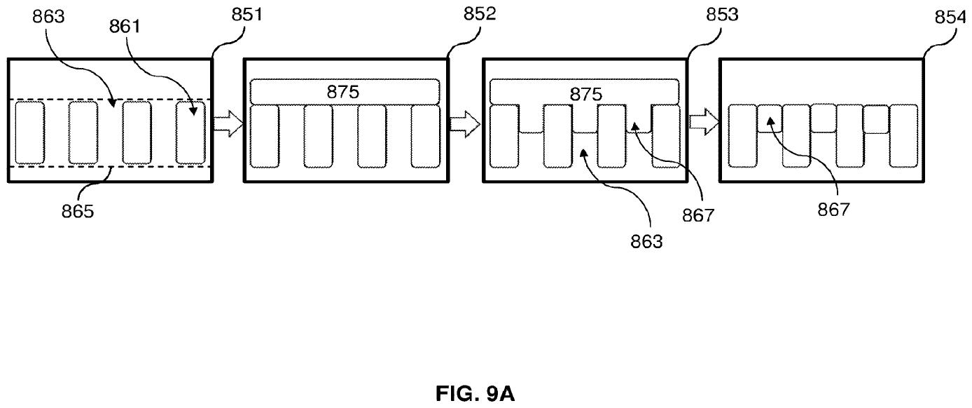

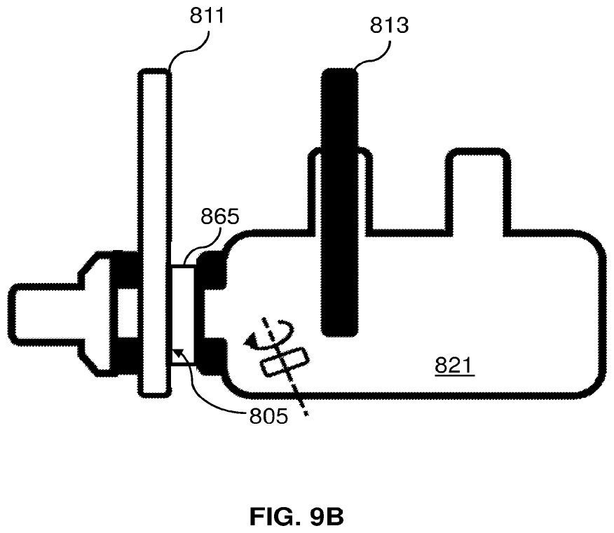

FIGS. 9A-9B provide another example of forming plug-type membranes with an electroplating process. As shown in FIG. 9A, a membrane 865 (between dashed lines 865) with isolated cylindrical pores 863 (between solid portions 861 of the membrane), shown at 851. Any of a variety of suitable membranes may be used, e.g., a ceramic membrane such as anodized aluminum oxide, also referred to herein as anodized alumina. The membrane may be coated with a thin metal layer 875, shown at 852 (e.g., a thin layer of palladium, indicated by the “Pd deposition” step of FIG. 9A). The thin metal layer may be deposited by any of a variety of suitable techniques, such as physical vapor deposition (e.g., sputtering) or chemical vapor deposition. Deposition of the thin metal layer may be followed by electrodeposition of hydrogen-selective metal (e.g. palladium or palladium alloy) into isolated cylindrical pores 863 to form plugs 867, shown at 853. Without wishing to be bound by any particular theory, in some embodiments the thin metal layer may be used as a nucleation site for plugs. FIG. 9B provides an exemplary plating setup that may be suitable for the electrodeposition of the plugs, illustrating membrane 865 disposed in electroplating setup 801 such that the thin metal layer on side 805 of membrane 865 contacts working electrode 811. The electroplating system further comprises counter electrode 813 and palladium electrolyte 821. As indicated in FIG. 9A, the thin metal film may then be removed by at 854 using any of a variety of suitable techniques (e.g., mechanical polishing), leaving plugs 867 in place.

In some embodiments, the inorganic layer may be coated onto a porous membrane via evaporation, sputtering, or other methods, with the metal being deposited inside of the pores at the surface to a depth on the order of the pore diameter. The surface of the membrane may be smooth, with roughness comparable to or smaller than the pore diameter at the surface. After deposition, the membrane surface may be polished or removed using mechanical, chemical, plasma-based, chemical-mechanical, or other means such that the deposited metal outside of the pores may be removed, leading to isolated metal deposits within the pores.

It should be appreciated that plug-type membranes represented by FIG. 6 may be especially stable for high temperature applications (e.g., dehydrogenation of fossil fuels) due to the isolation of the plugs from one another.

As shown in FIG. 6, the plugs 310 may have an average width W2 within the pores of the porous support 330. The plugs may have an average width W2 of any suitable size, including greater than or equal to 1 nm, 2 nm, 10 nm, 20 nm, 50 nm, 100 nm, 500 nm, 1 μm, 2 μm, 5 μm, 10 μm, and/or any other suitable size. The plugs 310 may also have an average width W2 or less than or equal to 10 μm, 5 μm, 2 μm, 1 μm, 500 nm, 100 nm, 50 nm, 20 nm, 10 nm, 2 nm, and/or any other suitable size. Combinations of the foregoing, including plugs 310 having an average width W2 between 2 nm and 1 μm, between 1 nm and 10 μm, and between 10 nm and 10 μm are also contemplated. It should also be appreciated that various pore shapes may be employed which may enhance the long-term thermal stability of the plugs. As such, the present disclosure is not limited by the size, shape, or arrangement of the plugs.

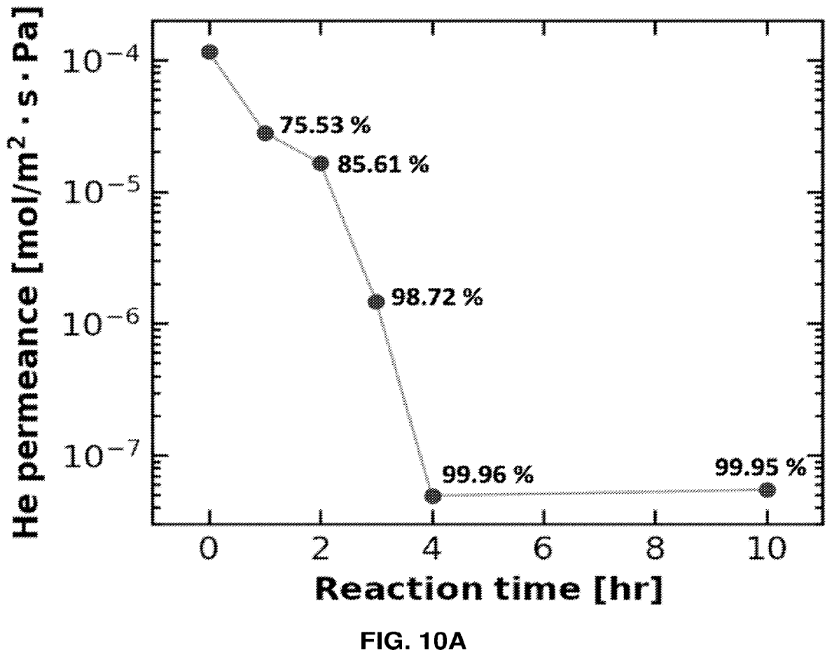

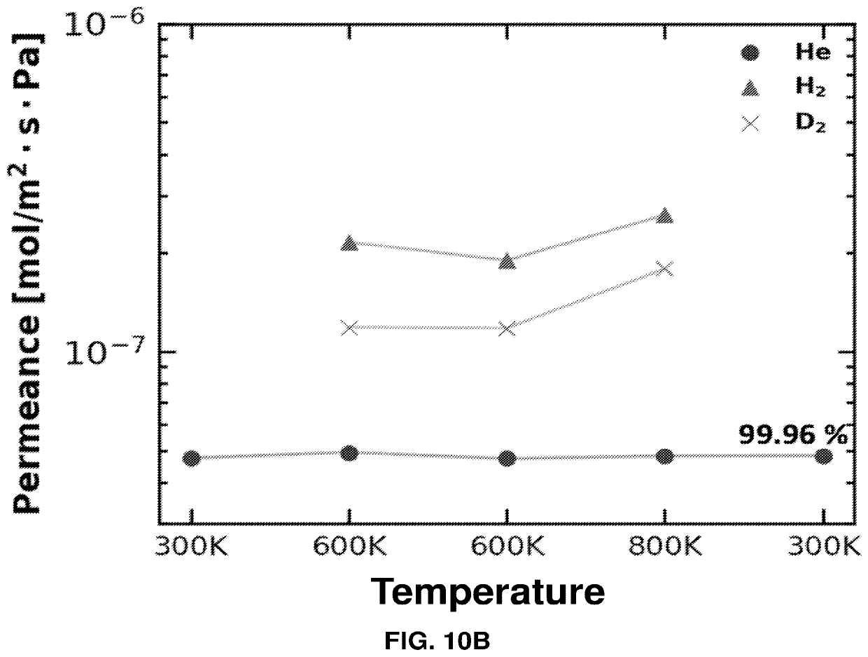

Similar to the island-type membrane of FIG. 4, the plug-type membrane of FIG. 6 may employ discrete, isolated bodies of material (e.g., palladium). The isolation between the plugs or islands may reduce the risk of solid-state dewetting, which may occur to minimize the surface area. Therefore, the fabrication processes may be optimized such that the plugs or islands are formed in a discrete manner. FIG. 10A shows a plot of helium permeance vs. galvanic displacement reaction time for a plug-type membrane. The numbers in the plots indicate the coverage of the inorganic plugs, suggesting that around 4 hours may be selected to create a discrete inorganic plug membrane. FIG. 10B shows a plot of permeance of various materials at different temperatures. First, permeance was measured at 300 K. Then the furnace was heated to 600K for approximately 12 hours, and the permeance was measured twice. The second measurement at 600K confirmed that the first measurement didn't deform the membrane. Then, the furnace was heated to 800K and annealed for approximately 12 hours. Finally, the temperature was reduced to 300 K and the permeance was measured once again. The helium permeance before and after annealing at 800 K for more than 12 hours showed negligible change, confirming the thermal stability of the membrane. The permeance data of FIG. 10B shows that the membrane may also operate as a hydrogen selective membrane at high temperatures.

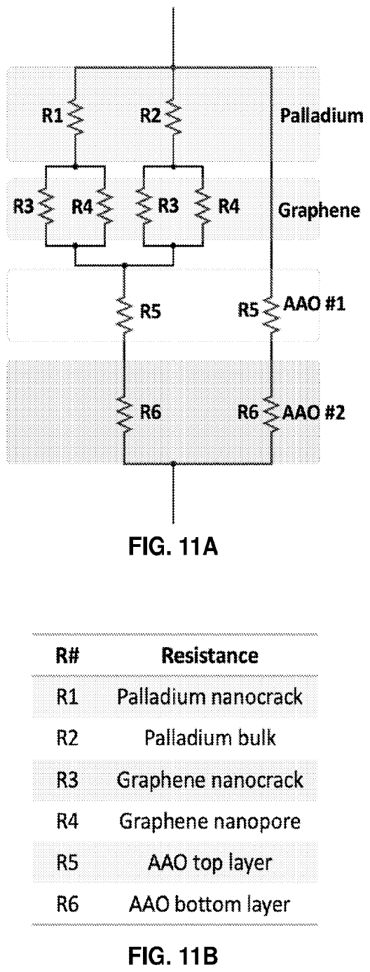

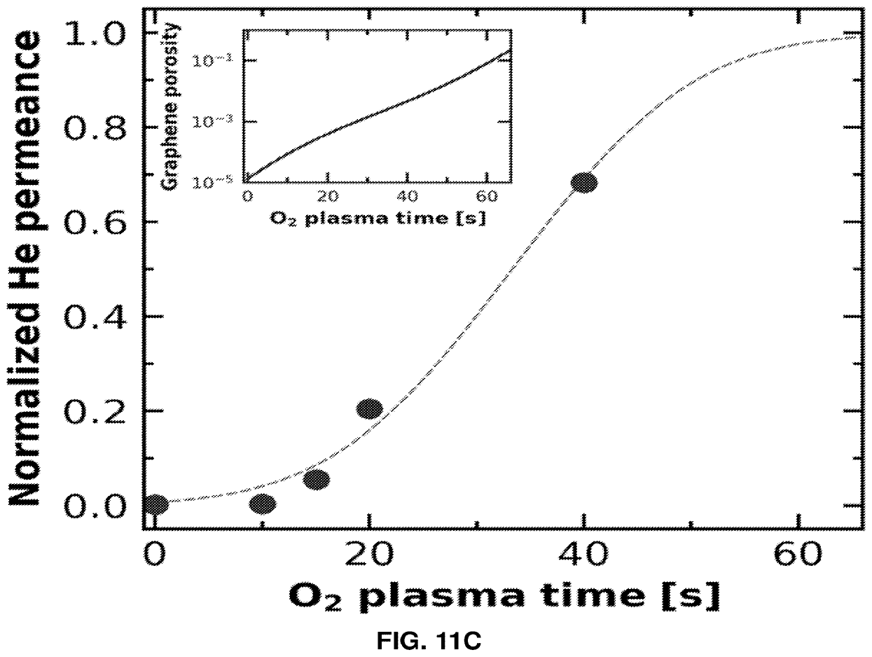

The Inventors have appreciated that identifying the gas transport mechanism is an essential step to understanding the membrane behavior, and optimizing the performance. To do so, key transport theories may be put together and implemented using a flow resistance circuit, which allows for the development of a comprehensive transport model for the film-type membrane. An exemplary film-type membrane may be divided into four different layers: palladium, graphene, AAO (porous support) top and bottom layers. Each layer may have a different number of pathways dictating the number of ways that the gas traverses the layer, as shown in FIG. 11A. For example, as shown in FIG. 11A, three different pathways exist in the palladium layer. R1 accounts for transport through the nanocracks, R2 is for bulk palladium transport (which is only applicable for hydrogen isotopes) and the last one with no resistance represents the region where palladium film does not cover the AAO support (leakage). Other resistances are listed in the table in FIG. 11B.

For the sake of simplification of the model, several key assumptions were made, including: (1) the mean free path of the gas is much larger than the pores or cracks in the membrane, and these pores/cracks are larger than the kinetic diameter of the gas molecules. In other words, gas transport (except through the bulk palladium) is governed by Knudsen transport, and there is no molecular sieving (no activated transport), (2) gas flow is explained by one-dimensional, transverse flow; lateral flow is negligible, (3) the graphene-covered area is the same as the palladium-covered area; palladium cannot cover the surface without a graphene layer, (4) the initial graphene layer is assumed to have no intrinsic defects. The effect of the defects was accommodated to the graphene coverage, (5) the pores in the AAO top layer are all connected to the pores in the bottom layer (no dead end for the top-layer pores). (6) all pores/cracks are modeled to be cylindrical, (7) the bulk palladium layer has activation-less adsorption. The bulk layer surface is homogeneous; no grain boundaries or roughness effect, (8) the bulk palladium diffusion of hydrogen and deuterium atoms are independent of each other, (9) rate constants regarding bulk palladium transport can be expressed as the Arrhenius equation, and the numerical values were based on the references, and (10) external mass transfer resistance is negligible compared to the membrane resistance. These assumptions enable the analytical calculation of the majority of the resistances in FIGS. 11A-11B.

The transport model may employ four important variables: graphene coverage, the porosity of the graphene nanopores, porosity of graphene defects, and porosity of the palladium. Graphene coverage represents the area where the palladium film is effectively covering owing to the underneath graphene layer. Tears, or large cracks created by the volume expansion of the palladium film may also be accounted for by this variable. The porosity of the graphene is related to the resistance R4 of FIGS. 11A-11B, indicating the porosity due to nanopores created by the oxygen plasma; the value is determined by the condition of the oxygen plasma treatment (e.g. plasma time). It should be appreciated that a porosity of the graphene pores may be used as an input variable instead of a graphene pore size to reduce the number of unknown parameters; having graphene pore size as an input necessitates additional parameter, i.e., the areal density of the pores (numbers/m²) to determine the porosity of the pores. Graphene defect porosity, affecting the resistance R3, reflects the defects in graphene created by the influence of the palladium expansion and contraction due to exposure to hydrogen, and possible damage during the metal deposition. Finally, palladium porosity presents the fraction of area corresponding to the palladium nanocracks, affecting both R1 and R2.

In addition to these variables, the model inputs may include the operating conditions, such as the upstream/downstream pressures, temperature, geometrical properties of the membrane (e.g. palladium thickness, average palladium crack size, support dimensions), and the sticking coefficient, which was assumed to be 1.

It should be appreciated that the model may account for the major kinetic steps across the palladium layer. Both surface reactions (e.g. adsorption, absorption, desorption) and the bulk diffusion were included in the model. Moreover, the model considers the isotopic effect between hydrogen and deuterium (or deuterium and tritium) by using total surface coverage or a total bulk ratio of both atoms. In other words, the model may be implemented for the analysis of both single-gas and mixed-gas permeation tests. Second, depending on the working environment of the membrane (e.g. temperature, pressure), the model may use different rate constants to take the palladium phase into account. To do so, the model employs a transition pressure equation which determines the phase of the palladium. By switching the rate constants under different operating conditions, the model effectively covers wide ranges of temperature/pressure spaces.

To evaluate the correlation between the plasma time and the porosity of the graphene nanopores, five graphene membranes were exposed to oxygen plasma for different times (0˜40 s) and measured to determine the helium permeance, as shown in FIG. 11C. Subsequently, the helium permeance normalized by the permeance of the AAO support was fitted to the error function, to identify the analytical equations. Using this information and a transport model of the graphene membrane, the porosity of the graphene nanopores, assuming the graphene coverage of 100%, may be estimated. This assumption may imply that the graphene nanopore porosity accounts for not just the plasma-induced pores, but also the initial defects on the graphene surface. The plot of the porosity of graphene nanopores versus the plasma time is shown in the inset of FIG. 11C.

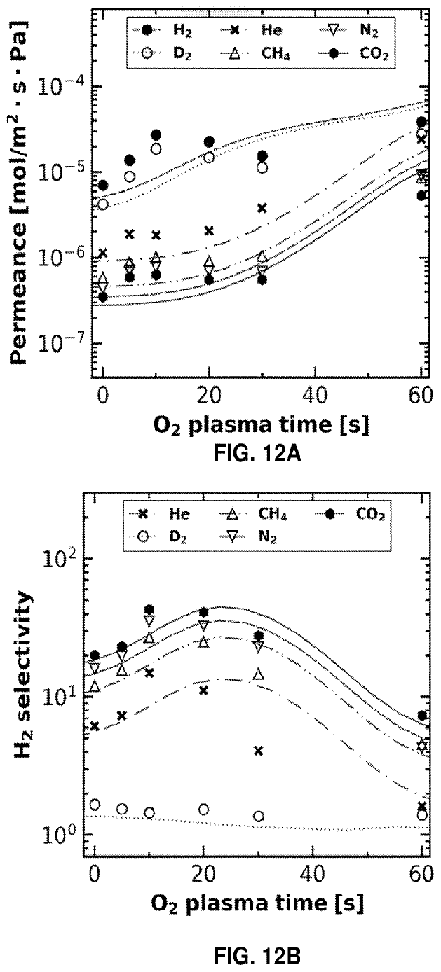

FIG. 12A shows experimental permeance data (shown with markers) and the transport model curves of the palladium film membranes with respect to the oxygen plasma time. The plot depicts the increasing permeance as the plasma time increases, although the increase rate differs depending on the gas species. It should be appreciated that the transport model captures the trend of the permeance with decent accuracy, considering that the measured data are from different membrane samples. FIG. 12B shows the change of hydrogen selectivity with plasma time. Although there are deviations at 10 s and 30 s, the variation of the selectivity with respect to the plasma time agrees well overall with the model curve. Both experiments and the model suggest that there is an optimal plasma time for the highest selectivity, around 20 s. Without wishing to be bound by theory, this optimal time may be attributed to the additional pathway (bulk palladium; see R2 in FIG. 11A) parallel to the one through the palladium cracks (see R1 in FIG. 11A), which may effectively lower the total flow resistance of the hydrogen isotopes at the optimal porosity of the graphene nanopores, allowing the highest selectivity against other gases.

In some embodiments, the model may be implemented to understand the membrane behavior at different temperatures. An exemplary membrane may be a palladium film membrane with a graphene layer exposed to 20 s of oxygen plasma, considering the optimized plasma time identified in FIG. 11C. The gas permeance was then measured using the sample starting at room temperature, and the change was monitored as the temperature increased. To ensure steady-state conditions, the membrane was kept overnight (˜12 hours) before the measurement whenever the temperature was altered. The permeance was then calculated using the flow meter at the permeate side, membrane area and the transmembrane pressure which was less than 50 kPa.

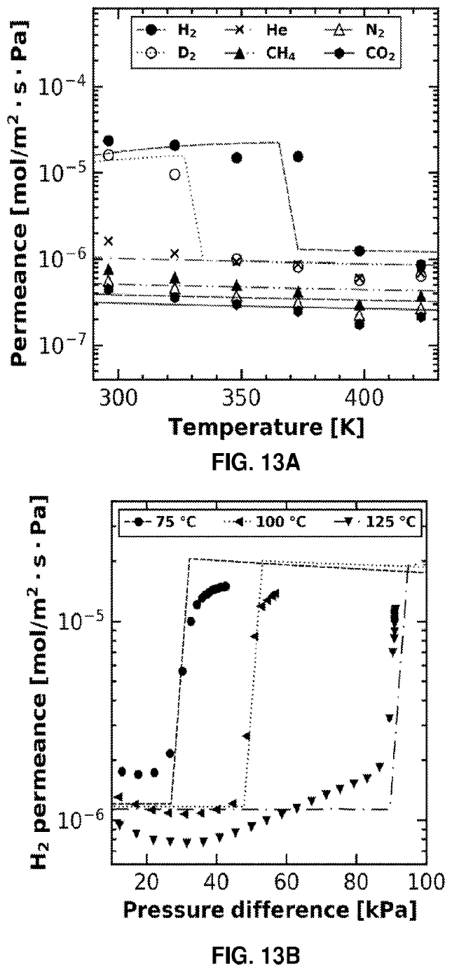

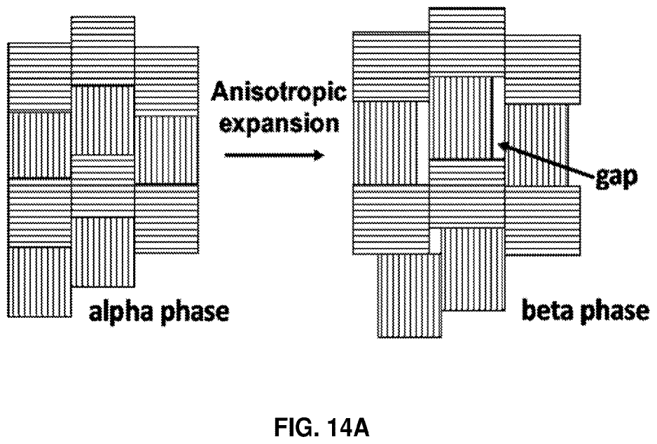

FIG. 13A shows exemplary results of the permeance tests. Besides for hydrogen isotopes, the gas permeances showed a mild decrease as the temperature rose, indicating that the transport is governed by Knudsen effusion. In the case of hydrogen isotopes, however, there was a certain temperature at which the permeance suddenly dropped by an order of magnitude. Without wishing to be bound by theory, the drop is related to the phase change of the palladium. Usually, when the temperature is higher than ˜600 K (critical temperature), palladium only shows a single phase: alpha. However, if the temperature is lower than 600 K, the palladium phase is determined by the gas pressure; the pressure at which the phase is shifted from alpha to beta is called the “transition pressure”. By monitoring the variation of the hydrogen permeance with respect to the transmembrane pressure, we found the transition pressure where the permeance shoots up, and correlated the pressure with the temperature using an Arrhenius form, as shown in FIG. 13B. As shown in FIG. 13A, the model accurately follows the experimental permeance drop of hydrogen and deuterium, implying that this sudden change is due to the palladium phase change under the low temperature condition.

For film-type membranes, the data suggests that the hydrogen and deuterium transport occur through the beta phase of palladium in the membrane. The graphene layer may therefore support the thin palladium film and reduce the risks of leakage through defects in the film.

It should be appreciated that other embodiments of the palladium film membrane include multi-layer membranes, consisting of alternate layers of porous graphene or other ultrathin material and inorganic layers. Yet other embodiments consist of composite selective layer consisting of stacked flakes of 2D material (including graphene oxide or reduced graphene oxide, with lateral dimensions large enough to cover defects in the inorganic material, (e.g., 50 nm to few microns in size), interspersed with inorganic material. It should be appreciated that the present disclosure is not limited to conformal films or continuous layers, and other structures such as islands or plugs are also contemplated.

Experimental tests using mixed gases, summarized in FIGS. 14A-14C, suggest that that the presence of hydrogen may increase the permeance of the other (non-hydrogen) gases. These observations indicate that the most likely mechanism is that phase change due to the presence of hydrogen may open up non-selective pathways across the palladium layer, as shown in FIG. 14A. These non-selective pathways may be gaps between palladium grains in the palladium layer created due to the expansion associated with phase transition between alpha and beta phases of the palladium. Thus, without wishing to be bound by theory, the membrane may function as a valve that regulates its permeance in a manner dependent on the partial pressure of hydrogen (or hydrogen isotopes) and the temperature at the palladium layer of the membrane, which governs the phase transition between alpha and beta phases. This behavior may find use in control of flow in response to the activity of hydrogen isotopes and the temperature. By setting a certain temperature, partial pressure of hydrogen at which the valve switches between on/off states can be set, as shown in FIGS. 14B-14C, which depict the change of gas permeance with respect to the H₂ ratio at the feed side having a binary mixture of He and H₂ (FIG. 14B) and N₂ and H₂, at operating temperature of 398 K, with the total pressure at the feed side of about 1 bar. Alternatively, the membrane may be used in a sensor, wherein measurement of the flow resistance of the membrane, in conjunction with temperature measurement or control, may be used to infer the partial pressure of hydrogen or hydrogen isotopes in a gas mixture, including distinguishing between mixtures of hydrogen isotopes in some cases.

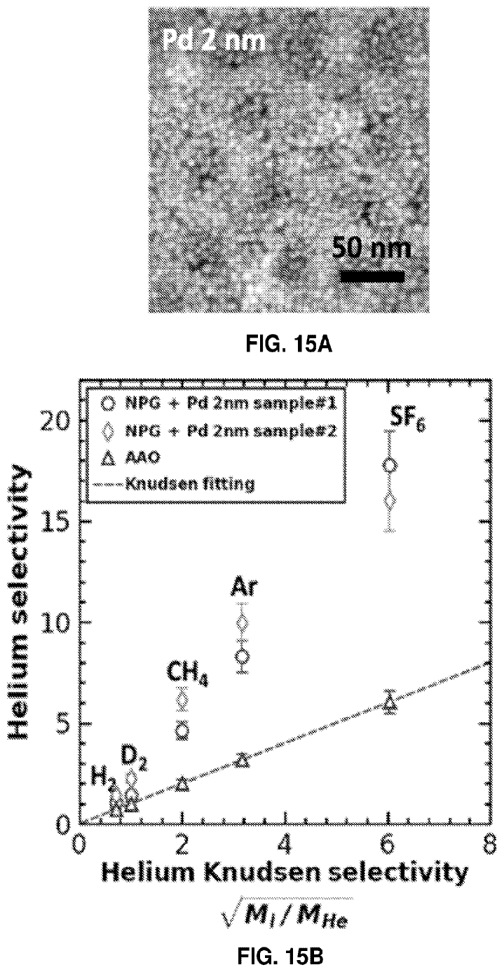

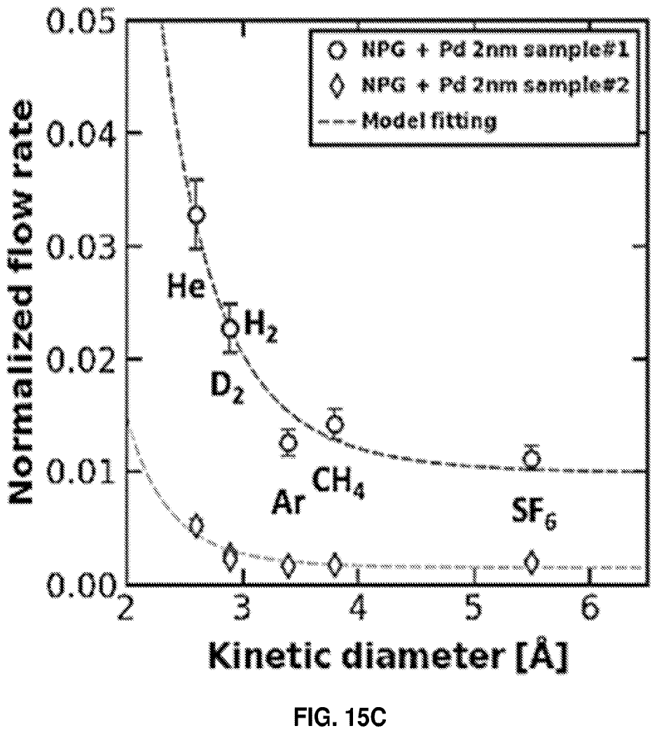

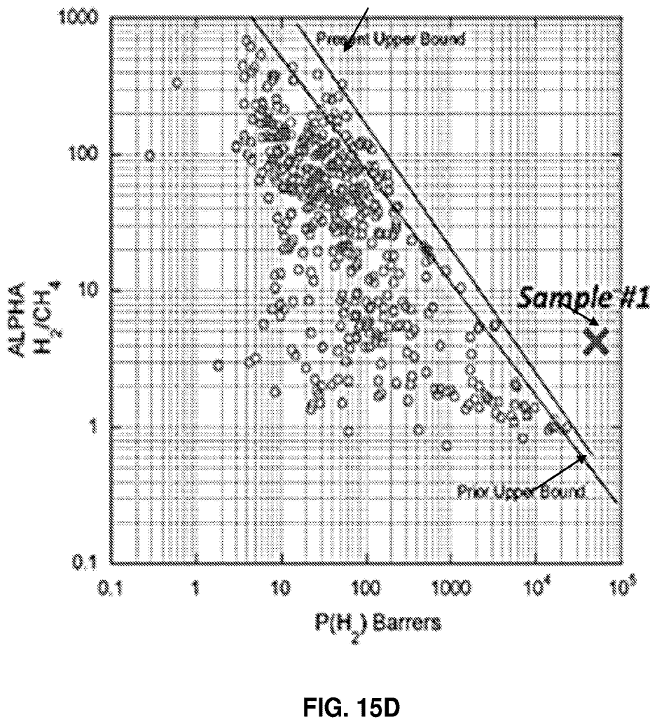

In another experiment, gas permeation tests were performed at room temperature in order to evaluate the performance of palladium islands on a graphene membrane (“the Pd islands membrane”). The membrane was fabricated by the transfer of a single graphene layer onto an anodic aluminum oxide (AAO) support, followed by an oxygen plasma etch of 20 s to create nanopores on the graphene surface. Subsequently, a thin Pd layer with a nominal thickness of 2 nm was deposited using an electron beam evaporator, producing the structure shown in FIG. 15A. Only a single step of Pd deposition was conducted for creating Pd islands since the gas permeation tests were performed at 300 K, where thermal de-wetting does not occur. Two Pd islands membranes fabricated using the same procedure were evaluated using single-gas permeation tests, and the results are shown in Table 2 and FIGS. 15B-15D. These two samples exhibited different permeances for the same gas component, which could be attributed to the quality of the graphene layer (e.g., the density of non-selective defects). However, both samples showed that helium had the highest permeance among all tested gas species including hydrogen and deuterium.

TABLE 2
Gas permeances and corresponding Helium selectivity
of Pd islands membranes (Sample #1 and #2
are fabricated using the same method)

| | Permeance [mol/m² · s · Pa] (Helium selectivity) | | |
|---|---|---|---|
| Gas species | | Sample #1 | Sample #2 |

| | | | | |
|---|---|---|---|---|
| He | 3.8E−6 | (1.0) | 6.0E−7 | (1.0) |
| H₂ | 3.6E−6 | (1.1) | 4.2E−7 | (1.4) |
| D₂ | 2.7E−6 | (1.4) | 2.7e−7 | (2.2) |
| CH₄ | 8.1E−7 | (4.6) | 9.7E−8 | (6.2) |
| Ar | 4.6E−7 | (8.3) | 6.0E−8 | (10.0) |
| SF₆ | 2.1E−7 | (17.8) | 3.7E−8 | (16.0) |

These results imply that although Pd is a hydrogen-selective material as described above, the Pd islands did not act as a selective pathway for hydrogen and its isotopes at low temperatures. Like the Pd film membrane described above, it appears the flow path through the Pd islands had a much higher resistance compared to the resistance of the graphene nanopores at low temperatures. Therefore, the transport via Pd islands had a negligible impact on the overall gas permeance. Instead, the results suggest that the size-selective graphene pores dominated the overall transport of gas species through the membranes FIG. 15B. Given that graphene nanopores created by oxygen plasma would not have resulted in enhanced helium selectivity due to non-selective defects, it is believed that Pd islands served as a sealing layer blocking these nanopores, and allowing the small pores (or partially blocked larger pores) to determine the overall membrane permeance. Indeed, without wishing to be bound by any particular theory, FIG. 15C shows that the normalized flow rates of gas species (normalized by flow rates of that gas species through the porous support, which had permeances of 1.15E-4 for He, 1.57E-4 for H₂, 1.17E-4 for D₂, 3.63E-5 for Ar, 5.73E-5 for CH₄, and 1.90E-5 for SF₆) are consistent with an assumption that the membrane operated by a molecular sieving mechanism (e.g., Knudsen diffusion, as described above), as indicated by the accuracy of the sieving model fitting curves indicated by dashed lines. The fitted overall coverages (comprising graphene and Pd islands) of sample #1 and #2 were 99.0% and 99.8% respectively, indicating that most of support pores are fully covered by graphene with Pd islands, and size-selective graphene pores are distributed within these support pores.

In order to assess the overall performance of the Pd islands membrane, the test results were compared to those of other membranes using a Robeson plot, shown in FIG. 15D. Sample #1 was located on the plot, assuming an active layer thickness of 1 μm, and using the graphene area (about 20% of total membrane area) to estimate the permeance of nanoporous graphene. The plot clearly exhibits that sample #1 is above the Robeson upper bound, indicating the Pd islands membrane exceeds the limit of the membrane performance determined by the trade-off correlation between selectivity and permeability. This enhanced performance is attributed to 1) use of an atomically thin graphene layer, and 2) Pd islands effectively blocking large defects, improving gas selectivity.

The tests of the Pd islands membrane have demonstrated high performance at low temperatures. As the islands are on flexible graphene surface in an isolated manner, the exposure to hydrogen or its isotopes does not lead to the irreversible structural deformations observed in Pd film membranes. This suggests that the membrane can potentially operate over a wide range of temperatures, e.g., from 300 K up to 1000 K or higher, depending on the embodiment.

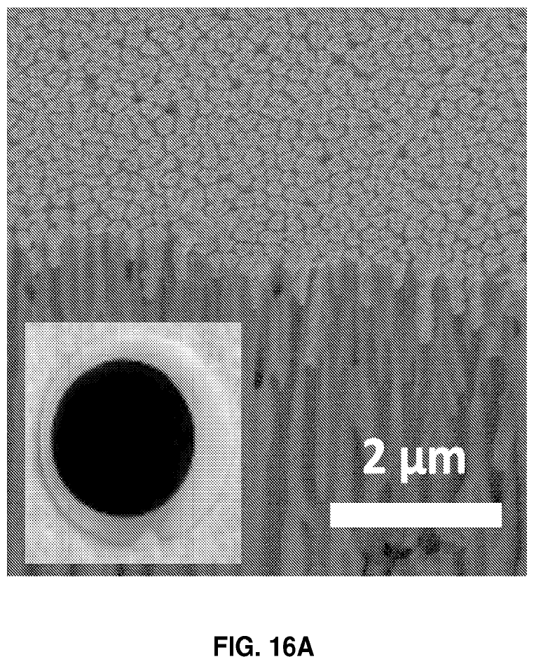

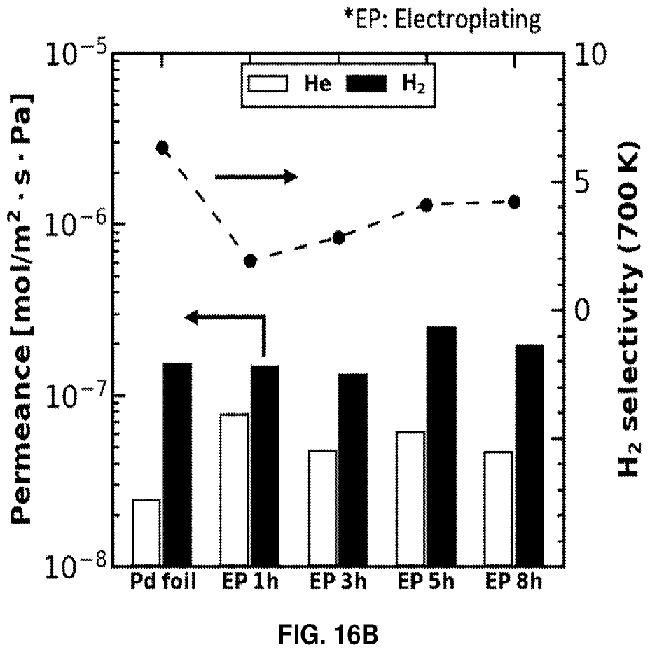

In yet another experiment, a membrane comprising a plurality of Pd plugs was fabricated by the method generally presented in FIG. 9A. On an anodic aluminum oxide support (AAO support), a thin Pd layer was deposited using sputtering. Two electrodes were used for plating: a working electrode (indium tin oxide glass) and a counter/reference electrode (graphite). The working electrode made direct contact with the thin Pd layer. After addition of the Pd electrolyte (a mixture of Pd(NH₃)₄Cl₂, NH₄Cl, and NH₄OH), a constant current (˜3 mA/m²) was applied to the electrodes using a power source to deposit the plugs. Different plating times were employed to adjust the density, and the length of the plugs. After the process, the thin Pd film was removed by mechanical polishing to isolate the Pd plugs inside the membrane. FIG. 16A presents an SEM micrograph of the membrane after fabrication.

The performance of metal plug membrane was evaluated using gas permeation tests at high temperatures (˜700 K). To reach the steady state, and ensure the thermal stability of the membrane, it was annealed for more than 24 h before conducting the gas permeation test. Then the permeances to two gas species (hydrogen and helium) were measured separately (indicated by bars in FIG. 16B), and the corresponding hydrogen selectivity was calculated based on the measurements (indicated by the black circles connected by dashed lines in FIG. 16B). Helium permeance through the bare AAO support was measured to be 3.9×10⁻⁴ mol/m²-s-Pa. A much lower permeance of the Pd plug membrane (˜5.0×10⁻⁸ mol/m²-s-Pa) was observed, suggesting that plugs formed inside most of the AAO pores, mitigating leakage flow even at high temperatures. The corresponding coverage of the plugs, defined as the permeance ratio between the plug membrane and the AAO support was close to 99.9%. Generally, helium permeance exhibited decreasing trend as the plating time increased from 1 h to 8 h, as indicated in FIG. 16B. This is because longer plating time increases the density of the Pd plugs as well as their average length, increasing the overall resistance of the leakage flow. Consequently, longer plating time increased the hydrogen selectivity, as shown in FIG. 16B.

The performance of Pd plug membranes was compared to a commercially available 12.5 μm thick Pd foil membrane (indicated as “Pd Foil in FIG. 16B). Both membranes achieved helium permeance with the same order of magnitude (˜10⁻⁸), but the foil showed slightly lower permeance due to its thick metal layer which mitigated the leakage through defects. In terms of hydrogen permeance, the thickness of the Pd foil layer hindered the transport of hydrogen, resulting in a lower H₂ lower permeance compared to Pd plug membranes. Consequently, hydrogen selectivity against helium was similar in both membranes, as indicated by the dark circles in FIG. 16B. Advantageously, the Pd plug membranes achieved compatible performances with Pd foil membranes while using much less Pd. Unlike the Pd foil having the film thickness of 12.5 μm covering entire membrane area, the Pd plug membrane had plugs typically thinner than 1 μm, and the plugs only covered the pores, not the entire substrate. Therefore, the plug membranes significantly improve the overall performance per gram of Pd, providing benefits for efficiency and/or cost effectiveness.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1. A membrane comprising:
a porous support layer;
an atomically thin layer disposed on the porous support layer, wherein the atomically thin layer includes a plurality of pores; and
a layer disposed on the atomically thin layer,
wherein the layer is formed of a hydrogen selective material.

2. The membrane of claim 1, wherein the layer is conformally disposed on the atomically thin layer.

3. The membrane of claim 2, wherein a thickness of the layer is between 20 nm and 200 nm.

4. The membrane of claim 1, wherein the layer is arranged as a plurality of isolated microstructures.

5. The membrane of claim 4, wherein an average width of the plurality of isolated microstructures is between 1 nm and 20 nm.

6. The membrane of claim 1, wherein the atomically thin layer has a porosity between 0.01% and 10%.

7. The membrane of claim 1, wherein a hydrogen flow resistance of the atomically thin layer is substantially similar to a hydrogen flow resistance of the layer.

8. The membrane of claim 1, wherein the porous support layer has a porosity between 10% and 60%.

9. The membrane of claim 1, wherein the hydrogen selective material is an inorganic material, and wherein the inorganic material is a metal.

10. The membrane of claim 1, wherein the hydrogen selective material is an inorganic material, and wherein the inorganic material is palladium.

11. The membrane of claim 1, wherein the porous support layer is formed of an anodized aluminum oxide material or of silicon.

12. The membrane of claim 1, wherein the membrane has a hydrogen permeance of greater than or equal to 1×10⁻⁸ mol/m²-s-Pa at a temperature of 300 K.

13. The membrane of claim 1, wherein the membrane has a hydrogen permeance of greater than or equal to 1×10⁻⁷ mol/m²-s-Pa at a temperature of 300 K.

14. A membrane comprising:
a porous support layer including a plurality of pores; and
a plurality of isolated plugs disposed at least partially in the plurality of pores of the porous support layer,
wherein the plurality of isolated plugs are isolated from one another, and wherein the plurality of isolated plugs are formed of a hydrogen selective material.

15. The membrane of claim 14, wherein an average width of the plurality of isolated plugs are between 10 nm and 1 μm.

16. The membrane of claim 14, wherein the porous support layer has a porosity between 10% and 60%.

17-21. (canceled)

22. A membrane comprising:
a porous support layer;
an atomically thin layer disposed on the porous support layer, wherein the atomically thin layer includes a plurality of pores that includes non-gas-selective defects in the atomically thin layer; and
a layer disposed on the atomically thin layer and arranged as a plurality of isolated microstructures,
wherein the layer is formed of a material, and
wherein at least some of the non-gas-selective defects of the plurality of pores are covered by the isolated microstructures.

23-24. (canceled)

25. The membrane of claim 22, wherein at least some of the pores of the plurality are uncovered.

26. The membrane of claim 25, wherein an average width of the plurality of isolated microstructures is between 1 nm and 20 nm.

27. The membrane of claim 22, wherein the atomically thin layer has a porosity between 0.01% and 10%.

28. The membrane of claim 22, wherein the porous support layer has a porosity between 10% and 60%.

29. A method of filtering a gas, the method comprising flowing a species included in the gas through the membrane of claim 1.
